(19) United States
(12) Patent Application Publication
(10) Pub. No.: US 2026/0321618 A1
(43) Pub. Date: Oct. 15, 2026

(54) ELECTRODE, SECONDARY BATTERY, BATTERY PACK, AND VEHICLE

(71) Applicant: KABUSHIKI KAISHA TOSHIBA, Kawasaki-shi (JP)

(72) Inventors: Kento KANO, Tokyo (JP); Yoshiaki MURATA, Kawasaki (JP); Keigo HOSHINA, Yokohama (JP); Yasuhiro HARADA, Isehara (JP)

(73) Assignee: KABUSHIKI KAISHA TOSHIBA, Kawasaki-shi (JP)

(21) Appl. No.: 19/467,933

(22) Filed: Feb. 3, 2026

(30) Foreign Application Priority Data
Mar. 19, 2025 (JP) 2025-045791

(51) Int. Cl. H01M 4/525; H01M 4/02; H01M 4/131; H01M 4/505; H01M 4/62

(52) U.S. Cl. CPC H01M 4/525; H01M 4/131; H01M 4/505; H01M 4/625; H01M 2004/021

(57) ABSTRACT

In general, according to an embodiment, an electrode includes an active material-containing layer containing an active material and a fibrous carbon material. The active material includes a primary particles containing a nickel containing composite oxide having a layered structure. An average particle size of the primary particles is within a range of 0.1 μm or more and 10 μm or less. FUₐᵥₑ of the primary particles is 0.70 or more. The FUₐᵥₑ is an average value of a coefficient of form unevenness FU represented by the following expression (1).

$$FU = \frac{f}{{f}_{c}} = \frac{4 π a}{{ℓ}^{2}} \qquad ( 1 )$$

In the expression (1), l is an outer peripheral length of each of the primary particles in a projected cross-section, and a is an area of the projected cross-section.

### CROSS-REFERENCE TO RELATED APPLICATION

This application is based upon and claims the benefit of priority from Japanese Patent Application No. 2025-045791, filed Mar. 19, 2025, the entire contents of which are incorporated herein by reference.

### FIELD

Embodiments described herein relate generally to an electrode, a secondary battery, a battery pack, and a vehicle.

### BACKGROUND

Secondary batteries including nonaqueous electrolyte secondary batteries such as lithium ion secondary batteries have been introduced not only in electronic devices such as mobile phones but also in vehicles such as hybrid automobiles and electric automobiles, and have been widespread. In these applications, large capacity performance, long life performance, improved output performance, and the like are required.

Examples of the positive electrode active material of the secondary battery include lithium nickel cobalt manganese oxide which is excellent in large capacity performance. A battery using lithium nickel cobalt manganese oxide for a positive electrode and lithium titanate for a negative electrode is characterized by, for example, being superior in rapid charge-discharge performance, long life performance and low temperature performance to a battery using a graphite-based negative electrode. On the other hand, the positive electrode active material needs to be improved. For example, lithium nickel cobalt manganese oxide is generally a polycrystalline system in which primary particles having a fine particle shape are aggregated to form secondary particles. A positive electrode using such an active material has a problem that an oxidation reaction between the positive electrode and an electrolyte is likely to occur, and there are marked gas generation and resistance increase.

### BRIEF DESCRIPTION OF DRAWINGS

FIG. 1 is a cross-sectional view schematically showing an example of a secondary battery according to an embodiment.

FIG. 2 is an enlarged cross-sectional view of section A of the secondary battery shown in FIG. 1.

FIG. 3 is a partially cut-out perspective view schematically showing another example of the secondary battery according to the embodiment.

FIG. 4 is an enlarged cross-sectional view of section B of the secondary battery shown in FIG. 3.

FIG. 5 is a perspective view showing another example of an electrode group.

FIG. 6 is a perspective view schematically showing an example of a battery module according to an embodiment.

FIG. 7 is an exploded perspective view schematically showing an example of a battery pack according to an embodiment.

FIG. 8 is a block diagram showing an example of an electric circuit of the battery pack shown in FIG. 7.

FIG. 9 is a partial transparent view schematically showing an example of a vehicle according to an embodiment.

FIG. 10 is a diagram schematically showing an example of a control system related to an electrical system in a vehicle according to an embodiment.

### DETAILED DESCRIPTION

According to an embodiment, an electrode is provided. The electrode includes an active material-containing layer containing an active material and a fibrous carbon material. The active material includes a primary particles containing a nickel containing composite oxide having a layered structure. An average particle size of the primary particles is within a range of 0.1 μm or more and 10 μm or less. FUₐᵥₑ of the primary particles is 0.70 or more. The FUₐᵥₑ is an average value of a coefficient of form unevenness FU represented by the following expression (1). In the expression (1), l is an outer peripheral length of each of the primary particles in a projected cross-section, and a is an area of the

$$\begin{matrix}( Math 1 ) & \\ FU = \frac{f}{{f}_{c}} = \frac{4 π a}{{ℓ}^{2}} & ( 1 )\end{matrix}$$

According to another embodiment, a secondary battery including a positive electrode, a negative electrode, and an electrolyte is provided. The negative electrode comprises the electrode according to the above embodiment.

According to another embodiment, a battery pack including the secondary battery according to the above embodiment is provided.

According to another embodiment, a vehicle in which the battery pack according to the above embodiment is mounted is provided.

### First Embodiment

According to an embodiment, an electrode is provided. The electrode includes an active material-containing layer containing an active material and a fibrous carbon material. The active material includes a primary particles containing a nickel containing composite oxide having a layered structure. An average particle size of the primary particles is within a range of 0.1 μm or more and 10 μm or less. FUₐᵥₑ of the primary particles is 0.70 or more, the FUₐᵥₑ is an average value of a coefficient of form unevenness FU represented by the following expression (1). In the expression (1), 1 is an outer peripheral length of each of the primary particles in a projected cross-section, and a is an area of the projected cross-section. In the expression (1), I represents a circular constant.

$$\begin{matrix}( Math 2 ) & \\ FU = \frac{f}{{f}_{c}} = \frac{4 π a}{{ℓ}^{2}} & ( 1 )\end{matrix}$$

It can be said that the projected cross-section of the particle becomes closer to a circular shape as FU becomes higher. That is, it can be said that particles having high FU have few irregularities (little unevenness) on the particle surface. If the projected cross-section has a circular shape, FU is 1.0. The average value FUₐᵥₑ of the coefficients of form unevenness FU (irregularity shape factors) for primary particles contained in the electrode according to the first embodiment is as high as 0.70 or more. Thus, it can be said that there are few irregularities (little unevenness) on the particle surface, and a surface area is small. Therefore, reactivity can be reduced. Thus, in the electrode, a side reaction can be unlikely to occur, so that discharge rate performance can be improved. In addition, since a side reaction is unlikely to occur, the electrode can be used at a high potential, for example.

The electrode according to the first embodiment further contains a fibrous carbon material. The fibrous carbon material may include a plurality of fibers. In a case where the fibrous carbon material is combined with particles having few irregularities (little unevenness) on the particle surface, electron conductivity can be improved, which is preferred. This mechanism is presumed to be as follows.

The fibrous carbon material, upon contact with a plurality of particles, can form a long electron-conducting path to improve electron conductivity. However, if particles having many irregularities on the particle surface are combined with the fibrous carbon material, the fibrous carbon material is likely to be entangled with the irregularities on the particle surface. In this case, the fibrous carbon material hardly come into contact with a plurality of particles.

The average value FUₐᵥₑ of the coefficients of form unevenness FU for primary particles contained in the electrode according to the embodiment is 0.70 or more. Thus, even if the fibrous carbon material is combined, the fibrous carbon material is unlikely to be entangled with irregularities on the particle surface. Thus, it can be made easy for the fibrous carbon material to come into contact with a plurality of primary particles. As a result, a long electron-conducting path is easily formed. An electrode in which a long electron-conducting path is formed has high electron conductivity, and therefore can improve discharge rate performance. In addition, low resistance can be maintained even after a charge-discharge cycle. Preferred FUₐᵥₑ is 0.85 or more.

There is a tendency that the larger the average particle size of primary particles, the easier the handling in industrial production can be. There is a tendency that the smaller the average particle size of primary particles, the more smoothly the diffusion of lithium ions in a solid can proceed. Since the average particle size of primary particles contained in the electrode according to the embodiment is within a range of 0.1 μm or more and 10 μm or less, handling is easy, and diffusion of lithium ions in a solid can smoothly proceed.

The particle size of a particle of the nickel containing composite oxide having a layered structure which is a single crystal monocrystalline is likely to be within a range of 0.1 μm or more and 10 μm or less. Therefore, in a case where the average particle size of primary particles is within a range of 0.1 μm or more and 10 μm or less, the primary particles can contain a large number of particles of the nickel containing composite oxide having a layered structure which is a single crystal. Particles of the nickel containing composite oxide having a layered structure which is a single crystal are preferred because the number of irregularities and/or level of unevenness on the particle surface is likely to decrease. A more preferred average particle size of the primary particles is within a range of 3 μm or more and 6 μm or less.

The electrode according to the embodiment will be described in more detail.

An average fiber length Lₐᵥₑ of the fibrous carbon material and an average value lₐᵥₑ of the outer peripheral length l of primary particles in the projected cross-section preferably satisfy the following expression (2).

lₐᵥₑ/Lₐᵥₑ≤5.0 Expression (2):

Satisfying the expression (2) means that the average fiber length Lₐᵥₑ of the fibrous carbon material is sufficiently larger than the average value lₐᵥₑ of l for primary particles. In this case, the fibrous carbon material is likely to come into contact with a plurality of particles, and therefore it is easy to form a long electron-conducting path. lₐᵥₑ/Lₐᵥₑ can be, for example, 0.1 or more and 4.8 or less.

There is a tendency that the larger the average fiber length Lₐᵥₑ of the fibrous carbon material, the more easily the fibrous carbon material can come into contact with a plurality of particles. In addition, by the fibrous carbon material coming into contact with a plurality of particles, strength of the active material-containing layer can be maintained even if a volume of the electrode is changed by charge-discharge. The average fiber length Lₐᵥₑ may be, for example, 0.3 μm or more, and is preferably 3.0 μm or more, and more preferably 4.0 μm or more. The average fiber length Lₐᵥₑ of the fibrous carbon material can be set to, for example, 50 μm or less. In a case where the average fiber length is in this range, dispersion in a solvent during production of the electrode can be facilitated, so that a process can be simplified. The average fiber length Lₐᵥₑ may be, for example, 6.4 μm or less. The average fiber length Lₐᵥₑ Can be, for example, 3.0 μm or more and 6.4 μm or less.

There is a tendency that the addition amount of the carbon material can be decreased as the average value lₐᵥₑ of the outer peripheral length l of primary particles in the projected cross-section becomes smaller. The number of primary particles that can contact per fiber length of the fibrous carbon material can be increased as the lₐᵥₑ of primary particles becomes smaller. Thus, even if the addition amount of the carbon material is reduced, an effect of adding the carbon material can be easily obtained. The average value of lₐᵥₑ of l for primary particles may be, for example, 35 μm or less, and is preferably 31.0 μm or less, and more preferably 15 μm or less. The average value lₐᵥₑ of l can be, for example, 0.1 μm or more. If the average lₐᵥₑ is in this range, dispersion in a solvent during production of the electrode can be facilitated, so that a process can be simplified. lₐᵥₑ may be, for example, 0.33 μm or more. lₐᵥₑ can be, for example, 0.33 μm or more and 31.0 μm or less.

Specific examples of the nickel containing composite oxide having a layered structure (layered nickel containing composite oxide) include nickel oxide, lithium nickel composite oxides (for example, LiₓNiO₂; 0<x≤1, LiₓNi₂O₄; 0<x≤1), lithium nickel cobalt composite oxides (for example, LiₓNi_{1-y}CO_{y}O₂; 0<x≤1, 0<y<1), lithium manganese nickel composite oxides (for example, LiₓMn_{2-y}Ni_{y}O₄ or LiₓMn_{1-z}Ni_{z}O₂; 0<x≤1, 0<y<2, 0<z≤1), and lithium nickel cobalt manganese composite oxides (LiₓNi_{1-y-z}CO_{y}Mn_{z}O₂; 0<x≤1, 0<y<1, 0<z<1, y+z<1). The nickel containing composite oxide having a layered structure may include one, or two or more of the above.

In a case where the electrode according to the embodiment is used as a positive electrode, examples of the nickel containing composite oxide having a layered structure include lithium nickel composite oxides (for example, LiₓNiO₂; 0<x≤1), lithium nickel cobalt composite oxides (for example, LiₓNi_{1-y}CO_{y}O₂; 0<x≤1, 0<y<1), lithium manganese nickel composite oxides having a spinel structure (for example, LiₓMn_{2-y}Ni_{y}O₄ or LiₓMn_{1-z}Ni_{z}O₂; 0<x≤1, 0<y<2, 0<z≤1), and lithium nickel cobalt manganese composite oxides (LiₓNi_{1-y-z}CO_{y}Mn_{z}O₂; 0<x≤1, 0<y<1, 0<z<1, y+z<1). These compounds are preferred because they can increase a positive electrode potential.

Examples of the nickel containing composite oxide having a layered structure that is preferred in a case where the electrode according to the embodiment is used in combination with an electrolyte and the electrolyte contains a room temperature molten salt include lithium nickel composite oxides, lithium nickel cobalt composite oxides, and mixtures thereof. These compounds have low reactivity with a room temperature molten salt, so that a cycle life can be improved. Details of the room temperature molten salt will be described later.

It is preferred that the primary particles containing a nickel containing composite oxide having a layered structure contain nickel, cobalt and manganese. The following expressions (3) and (4) are satisfied.

z/x≥1/3 Expression (3):

y≤2 Expression (4):

Here, x is a relative amount of nickel to a total amount of the nickel, the cobalt and the manganese; y is a relative amount of cobalt to the total amount; and z is a relative amount of manganese to the total amount. The total amount is assumed to be 10.

It can also be said that x is a ratio of nickel to the total amount where the total amount of nickel, cobalt and manganese contained in primary particles containing a nickel containing composite oxide having a layered structure is assumed to be 10. It can also be said that y is a ratio of cobalt to the total amount. It can also be said that z is a ratio of manganese to the total amount.

In the primary particles containing a nickel containing composite oxide having a layered structure, the smaller the relative amount x of nickel relative to the relative amount z of manganese, the larger the value on the left side of the expression (3). In the primary particles containing a nickel containing composite oxide having a layered structure, satisfying the expression (4) means that the relative amount y of cobalt is 2 or less where the total amount of nickel, cobalt and manganese is assumed to be 10.

That is, in the primary particles satisfying the expressions (3) and (4), the relative amount y of cobalt is as low as 2 or less, and the relative amount x of nickel is not excessively large relative to the relative amount z of manganese. Therefore, the amount of transition metals contributing to charge-discharge is relatively small. For this reason, stability in charge and discharge is high. As a result, the electrode according to the embodiment can be used at a high potential. As a result, a battery having a high energy density can be realized by incorporating the electrode according to the embodiment in the battery, for example.

However, in a case where the amount of transition metals contributing to charge-discharge is relatively small, the resistance of primary particles containing a nickel containing composite oxide having a layered structure tends to increase. The electrode according to the embodiment is capable of reducing the resistance by improving electron conductivity because it contains the fibrous carbon material described above. For this reason, initial resistance can be reduced even if primary particles which satisfy the above expressions (3) and (4) and in which the amount of transition metals is relatively small are contained. In addition, an increase in resistance which is associated with a charge-discharge cycle can be suppressed.

The primary particles containing a nickel containing composite oxide having a layered structure may be, for example, primary particles containing a nickel containing composite oxide having a layered structure satisfying the above expressions (3) and (4), or primary particles of a nickel containing composite oxide having a layered structure, or primary particles consisting of a nickel containing composite oxide having a layered structure. More specifically, the primary particles may be primary particles of a nickel containing composite oxide having a layered structure satisfying the above expressions (3) and (4).

Examples of the nickel containing composite oxide having a layered structure satisfying the above expressions (3) and (4) include oxides represented by the general expression A₁₋ₐNiₓB_{y}C_{z}O₂ and satisfying the above expressions (3) and (4). In the general expression, A is at least one element selected from the group consisting of H, Li, Na, K, Mg, and Ca. Each of B and C is at least one element selected from the group consisting of Mg, Ti, V, Cr, Mn, Fe, Co, Ni, Cu, Zn, and Al. B and C are elements that differ from each other. The general formula satisfies 0<a<1, 0<z<1, 0<y<1-x, 0<z<1-x-y.

Preferably, an active material-containing layer further contains a granular carbon material. A granular carbon material may include a plurality of particles. If the active material-containing layer contains the granular carbon material, gaps can be formed in the active material-containing layer. In a case where an electrode including gaps in the active material-containing layer is used in combination with, for example, an electrolyte, the electrolyte can be held in the gaps, so that ion conductivity can be improved, which is preferred.

The active material contained in the electrode according to the embodiment includes primary particles having few irregularities (little unevenness) on the particle surface as described above. In this electrode, the number of gaps contained in the active material-containing layer tends to be smaller than that in an electrode produced using particles having many irregularities on the particle surface. In a case where the electrode according to the embodiment further contains a granular carbon material, gaps can be formed in the active material-containing layer in the electrode including primary particles having few irregularities (little unevenness) on the particle surface.

An average primary particle size r′ of the granular carbon material is preferably not less than 5 times and not more than 12 times of an average fiber diameter r of the fibrous carbon material. If the average primary particle size r′ is within this range, gaps can be easily formed in the active material-containing layer. The average primary particle size r′ of the granular carbon material can be, for example, 0.009 μm or more and 0.021 μm or less. The average fiber diameter r of the fibrous carbon material may be, for example, 0.0017 μm or more and 0.0023 μm or less.

The electrode may include a current collector and an active material-containing layer. The active material-containing layer can be formed on one surface or both surfaces of the current collector. The active material-containing layer may contain an active material, an electro-conductive agent, and a binder. The active material-containing layer may further contain a dispersant.

In the electrode according to the first embodiment, the nickel containing composite oxide having a layered structure can function as an active material. The primary particles containing a nickel containing composite oxide having a layered structure can be active material particles.

The electrode according to the first embodiment can be a battery electrode which contains, as an active material for batteries, an active material including primary particles containing a nickel containing composite oxide having a layered structure. The electrode as a battery electrode can be, for example, a positive electrode which contains, as a positive electrode active material, an active material including a primary particles containing a nickel containing composite oxide having a layered structure.

In a case where the electrode according to the embodiment is used as a positive electrode, the positive electrode potential can be 3.0 V or more and 4.7 V (vs Li/Li⁺) or less. The positive electrode potential is preferably 4.2 V or more and 4.5 V (vs Li/Li⁺) or less. By increasing the positive electrode potential, a battery having a high energy density can be realized.

The active material may include primary particles containing a nickel containing composite oxide having a layered structure (first active material), or may be a mixture of primary particles containing a nickel containing composite oxide having a layered structure and one or more other active materials (second active material). The other active material can have a particle shape, for example. The active material may further include secondary particles containing a nickel containing composite oxide having a layered structure. The secondary particles can be aggregated primary particles containing a nickel containing composite oxide having a layered structure. In a case where the electrode according to the first embodiment is a positive electrode, examples of other active materials include oxides and sulfides. Examples of the oxide and sulfide include compounds capable of inserting and extracting Li or Li ions.

Examples of the other active material (second active material) include iron oxide, copper oxide, lithium manganese composite oxides (for example, LiₓMn₂O₄ or LiₓMnO₂; 0<x≤1), lithium cobalt composite oxides (for example, LiₓCoO₂; 0<x≤1), lithium manganese cobalt composite oxide (for example, LiₓMn_{y}Co_{1-y}O₂; 0<x≤1, 0<y<1), lithium phosphorus oxides having an olivine structure (for example, LiₓFePO₄; 0<x≤1, LiₓFe_{1-y}Mn_{y}PO₄; 0<x≤1, 0<y≤1, LiₓCoPO₄; 0<x≤1), iron sulfate (Fe₂(SO₄)₃), and vanadium oxide (for example, V₂O₅).

Examples of the second active material which is among the above and capable of increasing the positive electrode potential include a lithium manganese composite oxide having a spinel structure (for example, LiₓMn₂O₄; 0<y<1), lithium cobalt composite oxide (for example, LiₓCoO₂; 0<x≤1), lithium manganese cobalt composite oxide (for example, LiₓMn_{y}Co_{1-y}O₂; 0<x≤1, 0<y<1), and lithium iron phosphate (for example, LiₓFePO₄; 0<x≤1).

Examples of second active material that is preferred in a case where a room temperature molten salt as an electrolyte of battery include lithium iron phosphate, LixVPO₄F (0≤x<1), lithium manganese composite oxides, or mixture thereof. These compounds have low reactivity with a room temperature molten salt, so that the cycle life can be improved. Details of the room temperature molten salt will be described later.

The binder is blended for filling gaps in the dispersed active material and binding the active material and the current collector. Examples of the binder include polytetrafluoro ethylene (PTFE), polyvinylidene fluoride (PVdF), fluororubber, a polyacrylic acid compound, an imide compound, carboxymethyl cellulose (CMC), and salts of CMC. One of these may be used as the binder, or alternatively, two or more of these may be used in combination as the binder.

Each of the fibrous carbon material and the granular carbon material described above can function as an electro-conductive agent. The electro-conductive agent can enhance the current-collecting performance and suppress a contact resistance between the active material and the current collector. The electro-conductive agent may include a fibrous carbon material, and may contain a granular carbon material in addition to the fibrous carbon material.

Specific examples of the fibrous carbon material include vapor grown carbon fibers (VGCF), carbon nanotubes and carbon nanofibers. One or more than one kind of fibrous carbon material may be used. Specific examples of the granular carbon material include acetylene black, and carbon black. One or more than one kind of granular carbon material may be used.

The electro-conductive agent may further include electro-conductive agents other than the fibrous carbon material and the granular carbon material. Examples of the other electro-conductive agent include graphite, hard carbon, and graphene. One or more than one kind of other electro-conductive agent may be used.

The blending ratio of the active material, the electro-conductive agent, and the binder in the active material-containing layer can be appropriately changed according to a use of the electrode. For example, in a case where the electrode is used as a positive electrode of a secondary battery, the active material, the binder and the electro-conductive agent are preferably blended in ratios of 77% to 97.5% by mass, 2% by mass to 20% by mass, and 0.5% by mass to 15% by mass, respectively, in the active material-containing layer.

Setting the amount of the binder to 2% by mass or more can yield sufficient electrode strength. The binder can serve as an insulator. Thus, setting the amount of the binder to 20% by mass or less reduces the amount of an insulator included in the electrode and thus can decrease the internal resistance.

Setting the amount of the electro-conductive agent to 0.5% by mass or more can produce the above-described effects. Setting the amount of the electro-conductive agent to 15% by mass or less can decrease the proportion of the electro-conductive agent that contacts the electrolyte. If said proportion is low, decomposition of the electrolyte can be reduced during storage under high temperature.

The proportion of the nickel containing composite oxide having a layered structure (first active material) in the active material can be set to, for example, 20% by mass or more. The proportion of the nickel containing composite oxide having a layered structure in the active material may be 50% by mass or more, 90% by mass or more, or 100% by mass.

The proportion of the fibrous carbon material in the electro-conductive agent can be set to, for example, 0.01% by mass or more. The proportion of the fibrous carbon material in the electro-conductive agent may be 10% by mass or more, 30% by mass or more, or 100% by mass. In a case where the electro-conductive agent contains a granular carbon material, the proportion of the granular carbon material in the electro-conductive agent can be set to, for example, 18 by mass or more. The proportion of the granular carbon material in the electro-conductive agent may be 90% by mass or less, 70% by mass or less, or 20% by mass or less.

The current collector is preferably an aluminum foil (Al foil) or an aluminum alloy foil containing one or more elements selected from Mg, Ti, Zn, Ni, Cr, Mn, Fe, Cu, and Si.

The thickness of the aluminum foil or the aluminum alloy foil is preferably 5 μm or more and 20 μm or less, and more preferably 15 μm or less. The purity of the aluminum foil is preferably 99% by mass or more. The content of transition metals such as iron, copper, nickel, and chromium, which are contained in the aluminum foil or the aluminum alloy foil, is preferably 18 by mass or less.

In addition, the current collector may also include a portion that does not have the active material-containing layer formed on its surface. This portion can serve as a current-collecting tab.

### (Production Method)

The electrode according to the embodiment can be produced, as follows, for example.

First, particles containing a nickel containing composite oxide having a layered structure are prepared. In the particles containing a nickel containing composite oxide having a layered structure, the average value FUₐᵥₑ of the coefficient of form unevenness FU for primary particles may be lower than 0.70.

The particles containing a nickel containing composite oxide having a layered structure can be, for example, particles obtained by mixing starting materials, and then firing the mixture. However, the particles obtained by firing are likely to have many irregularities and/or high-level unevenness on the surface. In these particles, the average value FUₐᵥₑ of the coefficient of form unevenness FU for primary particles is likely to be lower than 0.70.

In addition, the particles obtained by firing can be secondary particles formed by aggregation of primary particles. Alternatively, primary particles can be bound to form a lump. For crushing the particles, a media mill or the like can be used. However, it is necessary to apply high pulverization energy for crushing the particles. For example, a medium having a large particle size can be used for obtaining high pulverization energy, As a result, the particles obtained after crushing are eventually likely to have many irregularities and/or high-level unevenness on the surface, where the average value FUₐᵥₑ of the coefficient of form unevenness FU for primary particles is lower than 0.70.

FU value adjustment is performed on the prepared particles containing a nickel containing composite oxide having a layered structure. The FU value adjustment can be performed by, for example, applying bead milling to the prepared particles containing a nickel containing composite oxide having a layered structure.

There is a tendency that the FU value for primary particles can be increased as the bead diameter in the bead milling is decreased. The bead diameter can be adjusted according to a state of the prepared particles containing a nickel containing composite oxide having a layered structure, and can be set to, for example, 500 μm or less. The bead diameter is preferably 200 μm or less, more preferably 100 μm or less, and still more preferably 50 μm or less. The bead diameter can be set to, for example, 20 μm or more. The bead diameter can be set to, for example, 50 μm. By setting a small bead diameter, and performing bead milling, irregularities (unevenness) on the surface of the particles containing a nickel containing composite oxide having a layered structure can be scraped. This may result in obtainment of primary particles having few irregularities (little unevenness) on the surface and the projected cross-section of the particles having a shape close to a circular shape.

There is a tendency that the FU value can be increased as the peripheral speed in the bead mill is increased. The peripheral speed can be set to, for example, 500 rpm or more and 2,000 rpm or less.

The bead milling can be performed over, for example, 5 minutes or more and 30 minutes or less.

By appropriately adjusting the above-described conditions for bead milling, and performing FU value adjustment, primary particles which contain a nickel containing composite oxide having a layered structure and in which the average value FUₐᵥₑ of the coefficient of form unevenness FU is 0.70 or more can be obtained. By adjusting the conditions for FU value adjustment, the average particle size of the primary particles can be set within a range of 0.1 μm or more and 10 μm or less.

Next, a slurry is produced. The slurry can be prepared by suspending the active material, the electro-conductive agent and the binder in a solvent. The active material includes primary particles containing a nickel containing composite oxide having a layered structure after FU value adjustment.

Specifically, the slurry can be prepared by kneading the active material and the binder to obtain a kneaded product, dispersing the electro-conductive agent in a solvent to obtain a dispersion liquid, and then adding the kneaded product to the dispersion liquid, followed by mixing.

The kneading (stiffening) of the active material and the binder can be performed by adding the binder to the active material after FU value adjustment, and applying a planetary mixer.

In the dispersion of the electro-conductive agent in the solvent, for example, n-methylpyrrolidone (NMP) can be used as the solvent. For the dispersion, for example, a bead mill can be used. In the dispersion liquid, a dispersant such as styrene-maleic acid copolymer may be further blended. In a case where a dispersant is blended, for example, the electro-conductive agent and the dispersant can be mixed, and then dispersed in a solvent.

In a case where the kneaded product is added to the dispersion liquid, followed by mixing, the mixing is preferably performed by a method involving a low shear force. For example, a jet paster is preferably used to perform the mixing. A slurry can be thus obtained.

The slurry is applied to either one surface or both surfaces of the current collector. The applied slurry is then dried to obtain a stack of the active material-containing layer and the current collector. Thereafter, the stack is pressed. In this way, an electrode can be produced.

The production method described above is capable of producing an electrode without applying a high shear force to the particles of a nickel containing composite oxide having a layered structure after FU value adjustment. Thus, the electrode can be produced while the average value FUₐᵥₑ of the coefficient of form unevenness FU for primary particles containing a nickel containing composite oxide having a layered structure is maintained at a desired numerical value (for example, 0.70 or more).

### (Measurement Method)

In a case where an electrode contained in a battery is an object to be measured, the electrode is taken out from the battery by the following procedure.

### (Extraction of Electrode)

First, the battery is brought into a completely discharged state. The battery can be brought into a discharged state by discharging the battery to a rated final voltage at a current of 0.1 C in an environment at 25° C.

Next, the battery is disassembled in a glove box filled with argon, and an electrode assembly (or an electrode group) is taken out. The electrode assembly is washed with an appropriate solvent, and dried under reduced pressure at 60° C. for 12 hours. As a washing solvent, for example, ethyl methyl carbonate can be used. The electrolyte contained in the electrode assembly can be thus removed. Thereafter, by cutting the electrode, electrode pieces to be measured can be obtained.

### (Extraction of Active Material)

In a case where in the electrode, the active material is an object to be measured, the active material is taken out from the electrode by the following procedure.

First, the electrode is cut to obtain two electrode pieces. One of the obtained electrode pieces is immersed in a solvent (preferably an organic solvent such as alcohol or NMP), and an ultrasonic wave is applied. By this, the current collector and an electrode constituent material contained in the electrode assembly can be separated. Next, the dispersion solvent in which the electrode constituent material is dispersed is treated with a centrifuge to separate the active material from the powder of the electrode assembly containing an electro-conductive agent such as carbon.

### (Measurement of Average Particle Size)

Next, a method for measuring the average particle size of the active material prepared as described above will be described.

The average particle size (average primary particle size) of the primary particles containing a nickel containing composite oxide having a layered structure can be measured by observing a scanning electron microscope (SEM) image. Whether or not particles to be measured are primary particles is determined by observation with the SEM. The fact that the primary particles to be measured contain a nickel containing composite oxide having a layered structure can be confirmed by identifying the composition of the primary particles through SEM-energy dispersive X-ray spectroscopy (SEM-EDX) measurement which will be described later.

The active material is bonded onto a stage for SEM with a carbon tape, and observed at a magnification for particles in which the boundary line of the outer periphery (contour) of the primary particle can be visually recognized with clarity, for example, a 500-fold to 10,000-fold magnification. The particle size of each of 100 arbitrary particles in the SEM image is determined by the following procedure. A circle enclosing a particle of interest (that is, a circumscribed circle) is drawn so as to minimize its diameter (the circle is referred to as a smallest circumscribed circle), and the diameter of the circle is defined as a particle size. The average value of particle sizes determined for the 100 arbitrary particles is obtained as an average particle size of primary particles. The average particle size of the primary particles which is obtained by the above-described method can be used as an alternative to D50.

### (Measurement of Coefficient of Form Unevenness FU)

The coefficient of form unevenness FU for each of a primary particles contained in the electrode can be measured as follows. For the specific definition of the coefficient of form unevenness FU, the contents of Non-Patent Literature 1 (Yuji Yoshimura and Shoji Ogawa (1993), SIMPLE QUANTIFICATION METHOD FOR GRAIN SHAPE OF GRANULAR MATERIALS SUCH AS SAND) are cited by reference.

The other of the previously prepared electrode pieces is bonded onto a stage for SEM with a carbon tape. Here, the electrode piece is bonded such that the active material-containing layer can be observed in a direction perpendicular to the layer. The central part of the electrode in the lateral direction is observed at a total of 100 points at equal intervals in the longitudinal direction from the end of the electrode. At each observation point, one primary particle is selected from particles in which the boundary line of the outer periphery (contour) of the primary particle can be visually recognized with clarity. In this way, a total of 100 primary particles are taken as objects to be measured. In a case where FU is measured for primary particles contained in a powdered sample such as active material particles, first, powder to be measured is bonded to a carbon tape. For the powder attached to the carbon tape, FU can be measured by performing observation in the same manner as described above. The observation magnification is a magnification for particles in which the boundary line of the outer periphery (contour) of the primary particle can be visually recognized with clarity, for example, 5,000-fold to 20,000-fold.

With images of the 100 primary particles, an outer peripheral length l of each of particles of interest and a cross-section area a of the particle of interest are determined using an image analysis tool. As an image analysis tool, for example, ImageJ described in Non-Patent Literature 2 (Dr. Michael et al., Image Processing with ImageJ, Reprinted from the July 2004 issue of Biophotonics International copyrighted by Laurin Publishing Co. INC.) can be used. From the obtained outer peripheral length l and cross-section area a, the coefficient of form unevenness FU for each of the selected 100 primary particles is calculated by the following formula (1). Further, an average value of the calculated 100 coefficient of form unevenness FU is calculated. The value can be used as the average value FUₐᵥₑ of the coefficient of form unevenness FU for primary particles containing a nickel containing composite oxide having a layered structure, which are contained in the active material-containing layer. The average value of the outer peripheral lengths l of the particles of interest, which are determined with the images of the 100 primary particles here can be taken as the average outer peripheral length lₐᵥₑ (μm).

$$\begin{matrix}( Math 3 ) & \\ FU = \frac{f}{{f}_{c}} = \frac{4 π a}{{ℓ}^{2}} & ( 1 )\end{matrix}$$

### (Determination of Type and Measurement of Size for Carbon Material)

The type of a carbon material contained in the electrode can be determined by analysis with a scanning electron microscope (SEM). Among the particles and/or fibers observed in the secondary electron image of the electrode, those that are the smallest in size (particle size or fiber length) are carbon materials. The particles that are the largest in particle size are active material particles.

Reflected electron image analysis is performed in a field of view which includes the active material particles and the carbon material that are identified as described above. The condition for acquiring the field of view is set such that the active material particles and the carbon material identified by the above-described method have lightness which allows for determination by a luminance. Examples thereof include measurement at 1 kV-10 uA in a reflected electron image, but the conditions are not limited to those described above. The conditions can be adjusted depending on the type of active material and the like.

For the fiber diameter of the fibrous carbon material, a distance over which a line perpendicular to a straight line drawn along one side of the fiber extends until intersecting the other side of the fiber is defined as the fiber diameter. The average fiber diameter can be determined by measuring fiber diameters of ten fibrous carbon materials randomly selected from the field of view and calculating an average value thereof. The fiber length of the fibrous carbon material can be determined by extrapolating a curve along one side of the fiber over the range within the field of view to measure the length of the curve. The average fiber length can be determined by selecting the ten longest extrapolated curves, and calculating the average length of the curves.

The average primary particle size of the granular carbon materials is obtained by measuring the diameter of the largest circle inscribed in each granular carbon material for the ten granular carbon materials randomly selected from the field of view, and calculating the average value of the diameters (average particle size).

### (Analysis of Composition of Primary Particles)

The composition of the primary particles containing a nickel containing composite oxide having a layered structure can be identified by EDX. A method for performing SEM-EDX measurement will be described below.

In a case where an electrode containing primary particles to be measured is incorporated in a battery, first, the battery is disassembled in a glove box filled with argon, and the electrode is taken out, and washed with an appropriate solvent. As the appropriate solvent, for example, ethyl methyl carbonate can be used. If the washing of the electrode is not sufficient, impurity phases such as lithium carbonate and lithium fluoride may enter due to remaining of lithium ions in the electrode. In this case, it is preferred to use an airtight container that allows the measurement to be performed in an inert gas atmosphere. Here, peaks derived from a metal foil as a current collector, an electro-conductive agent, a binder and the like are confirmed by performing measurement in advance using EDX. Of course, this operation can be omitted if the peaks can be confirmed beforehand. If the peak from the current collector and the peak from the active material overlap each other, it is desirable to peel the active material-containing layer from the current collector, followed by measurement. This is because overlapping peaks are separated in quantitative measurement of peak intensity. The active material-containing layer may be physically peeled. The active material-containing layer is easily peeled if an ultrasonic wave is applied in an appropriate solvent. In a case where ultrasonication is performed for peeling the active material-containing layer from the current collector, the electrode assembly powder (including the active material, the electro-conductive agent and the binder) as a sample can be recovered by evaporating the solvent. The powder of the active material which is taken out from the electrode by the method described above may be used as a sample.

In a case where the sample of interest is powder, it is desirable to observe the cross-sections of particles by embedding the sample in a resin or the like, and exposing the inside of the specimen by scraping by mechanical polishing, ion milling or the like. In addition, similar treatment can be performed even if the sample of interest is an electrode assembly. The electrode assembly can be directly embedded in a resin, followed by observation of a desired portion, or the current collector (metal foil) can be peeled from the electrode assembly, followed by observation as electrode powder in which an electro-conductive agent and a binder are mixed.

It is confirmed by SEM observation that the object to be measured is primary particles, and nickel, cobalt, and manganese on the cross-sections of the particles are mapped using EDX. The balance point of the cross-section of the particle of interest is regarded as the center of the particle (measurement point A). Next, five points X are set at equal intervals on a straight line connecting the particle gravity center and an arbitrary point on the particle surface. In a region orthogonally crossing each of the points X, a point corresponding to 80% of a distance from the center of gravity to the particle surface in a direction toward the outer shell (surface) is regarded as a measurement point B. EDX measurement is performed on the measurement point to obtain the intensity ratio of nickel, cobalt and manganese. This is performed at each of the points, and the average value of the obtained intensity ratios is taken as a composition of the particles of interest.

The electrode according to the first embodiment includes an active material-containing layer containing an active material and a fibrous carbon material. The active material includes a primary particles containing a nickel containing composite oxide having a layered structure. The average particle size of a primary particles which is obtained by a laser diffraction scattering method is within a range of 0.1 μm or more and 10 μm or less. FUₐᵥₑ of the primary particles is 0.70 or more. The FUₐᵥₑ is an average value of a coefficient of form unevenness FU represented by the following expression (1). In the expression (1), 1 is an outer peripheral length of each of the primary particles in a projected cross-section, and a is an area of the

$$\begin{matrix}( Math 4 ) & \\ FU = \frac{f}{{f}_{c}} = \frac{4 π a}{{ℓ}^{2}} & ( 1 )\end{matrix}$$

Thus, an electrode capable of realizing a secondary battery having excellent discharge rate performance can be provided.

### Second Embodiment

According to a second embodiment, a secondary battery including a negative electrode, a positive electrode, and an electrolyte is provided. The secondary battery includes the electrode according to the first embodiment as a positive electrode.

The secondary battery may further include a separator disposed between the positive electrode and the negative electrode. The negative electrode, the positive electrode and the separator can form an electrode group. The electrolyte may be held in the electrode group.

In addition, the secondary battery may further include a container member that houses the electrode group and the electrolyte.

Further, the secondary battery may further include a negative electrode terminal electrically connected to the negative electrode and a positive electrode terminal electrically connected to the positive electrode.

The secondary battery can be, for example, a lithium secondary battery. The secondary battery includes a nonaqueous electrolyte secondary battery containing a nonaqueous electrolyte.

Hereinafter, the negative electrode, the positive electrode, the electrolyte, the separator, the container member, the negative electrode terminal, and the positive electrode terminal will be described in detail.

### 1) Negative Electrode

The negative electrode may include a negative electrode current collector and a negative electrode active material-containing layer. The negative electrode active material-containing layer can be formed on one surface or both surfaces of the negative electrode current collector. The negative electrode active material-containing layer may contain a negative electrode active material, and optionally an electro-conductive agent and a binder.

Examples of the negative electrode active material include lithium titanate having a ramsdellite structure (for example, Li_{2+y}Ti₃O₇, 0≤y≤3), lithium titanate having a spinel structure (for example, Li₄₊ₓTi₅O₁₂, 0≤x≤3), titanium dioxide (TiO₂), anatase-type titanium dioxide, rutile-type titanium dioxide, niobium pentoxide (Nb₂O₅), hollandite-type titanium composite oxides, orthorhombic titanium composite oxides, and monoclinic niobium titanium oxides, graphite, silicon, SiO, Li, Bi, Sb, P, Sn, Al, Ge, and FeF₃.

Examples of the orthorhombic titanium-containing composite oxide include compounds represented by Li₂₊ₐM^{I}_{2-b}Ti_{6-c}M^{II}_{d}O_{14+σ}. Here, M^{I} is at least one selected from the group consisting of Sr, Ba, Ca, Mg, Na, Cs, Rb, and K. MIT is at least one selected from the group consisting of Zr, Sn, V, Nb, Ta, Mo, W, Y, Fe, Co, Cr, Mn, Ni, and Al. The respective subscripts in the composition formula are specified as follows: 0≤a≤6, 0<b≤2, 0≤c<6, 0≤d<6, and −0.5≤σ≤0.5. Specific examples of the orthorhombic titanium-containing composite oxide include Li₂₊ₐNa₂Ti₆O₁₄ (0≤a≤6).

Example of the monoclinic niobium titanium oxide is compounds represented by LiₓTi_{1-y}M1_{y}Nb_{2-z}M2_{z}O_{7+δ}. Here, M1 is at least one selected from the group consisting of Zr, Si, and Sn. Here, M2 is at least one selected from the group consisting of V, Ta, and Bi. The respective subscripts in the composition formula are specified as follows: 0≤x≤5, 0≤y<1, 0≤z<2, and −0.3≤δ≤0.3. Specific examples of the monoclinic niobium titanium oxide include LiₓNb₂TiO₇ (0≤x≤5).

Other examples of the monoclinic niobium titanium oxide include compounds represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formula are specified as follows: 0≤x≤5, 0≤y<1, 0≤z<2, and −0.3≤δ≤0.3.

The electro-conductive agent is added to enhance the current-collecting performance and to suppress contact resistance between the negative electrode active material and the negative electrode current collector. Examples of the electro-conductive agent include carbonaceous materials such as vapor grown carbon fibers (VGCF), carbon black such as acetylene black, graphite, carbon nanotubes, and carbon nanofibers. One of these may be used as the electro-conductive agent, or alternatively, two or more of these may be used in combination as the electro-conductive agent. Alternatively, the surfaces of the negative electrode active material particles may be coated with carbon or an electron-conductive inorganic material instead of use of the electro-conductive agent.

The binder is blended for filling gaps in the dispersed negative electrode active material and binding the negative electrode active material and the negative electrode current collector. Examples of the binder include polytetrafluoro ethylene (PTFE), polyvinylidene fluoride (PVdF), fluororubber, styrene butadiene rubber, a polyacrylic acid compound, an imide compound, carboxymethyl cellulose (CMC), and salts of CMC. One of these may be used as the binder, or alternatively, two or more of these may be used in combination as the binder.

The blending ratio of the negative electrode active material, the electro-conductive agent, and the binder in the negative electrode active material-containing layer can be appropriately changed. For example, the negative electrode active material, the electro-conductive agent and the binder are preferably blended in ratios of 68% by mass to 96% by mass, 2% by mass to 30% by mass, and 2% by mass to 30% by mass, respectively. By setting the amount of the electro-conductive agent to 2% by mass or more, the current-collecting performance of the negative electrode active material-containing layer can be improved. In addition, if the amount of the binder is 2% by mass or more, the binding property between the negative electrode active material-containing layer and the negative electrode current collector is sufficient, and excellent cycle performance can be expected. On the other hand, the amount of each of the electro-conductive agent and the binder is preferably 30 mass % or less for increasing the capacity.

For the negative electrode current collector, a material that is electrochemically stable at a potential where lithium (Li) is inserted into and extracted from the active material is used. For example, the negative electrode current collector is preferably made from copper, nickel, stainless steel or aluminum, or an aluminum alloy containing one or more elements selected from Mg, Ti, Zn, Mn, Fe, Cu, and Si. The thickness of the negative electrode current collector is preferably 5 μm to 20 μm. The negative electrode current collector having such a thickness can maintain a balance between the strength and weight reduction of the negative electrode. In addition, the negative electrode current collector may also include a portion that does not have the negative electrode active material-containing layer formed on its surface. This portion can serve as a negative electrode current-collecting tab.

The negative electrode can be produced, for example, by the following method. First, the negative electrode active material, the electro-conductive agent and the binder are suspended in a solvent to prepare a slurry. The slurry is applied to either one surface or both surfaces of the negative electrode current collector. The applied slurry is then dried to obtain a stack of the negative electrode active material-containing layer and the negative electrode current collector. Thereafter, the stack is pressed. The negative electrode is thus produced.

Alternatively, the negative electrode may be produced by the following method. First, the negative electrode active material, the electro-conductive agent, and the binder are mixed to obtain a mixture. Next, the mixture is formed into pellets. These pellets are then arranged on the negative electrode current collector, whereby the negative electrode can be obtained.

The density of the negative electrode active material-containing layer (not including the current collector) is preferably 1.8 g/cm³ or more and 2.8 g/cm³ or less. The negative electrode in which the density of the negative electrode active material-containing layer is within the above-mentioned range is excellent in energy density and electrolyte retainability. The density of the negative electrode active material-containing layer is more preferably 2.1 g/cm³ or more and 2.6 g/cm³ or less.

### 2) Positive Electrode

The positive electrode current collector and the positive electrode active material-containing layer may be a current collector and an active material-containing layer that may be contained in the electrode according to the first embodiment, respectively. The active material contained in the electrode according to the first embodiment can be contained in the positive electrode active material-containing layer as a positive electrode active material.

A part of the details of the positive electrode, which overlaps the details described in the first embodiment, will be omitted. The positive electrode can be produced by, for example, a method similar to that for the electrode according to the first embodiment.

### 3) Electrolyte

As the electrolyte, for example, a nonaqueous electrolyte can be used.

As the nonaqueous electrolyte, for example, a liquid nonaqueous electrolyte or a gel nonaqueous electrolyte can be used. The liquid nonaqueous electrolyte is prepared by dissolving an electrolyte salt as a solute in an organic solvent. The concentration of the electrolyte salt is preferably 0.5 mol/L or more and 2.5 mol/L or less.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LiN(CF₃SO₂)₂], and mixtures thereof. The electrolyte salt is preferably resistant to oxidation even at a high potential, and most preferably LiPF₆.

Examples of the organic solvent include cyclic carbonates such as propylene carbonate (PC), ethylene carbonate (EC), or vinylene carbonate (VC); linear carbonates such as diethyl carbonate (DEC), dimethyl carbonate (DMC), or methyl ethyl carbonate (MEC); cyclic ethers such as tetrahydrofuran (THF), 2-methyl tetrahydrofuran (2-MeTHF), or dioxolane (DOX); linear ethers such as dimethoxy ethane (DME) or diethoxy ethane (DEE); γ-butyrolactone (GBL), acetonitrile (AN), and sulfolane (SL). These organic solvents may be used singularly or as a mixed solvent.

The gel nonaqueous electrolyte (gelatinous nonaqueous electrolyte) is prepared by obtaining a composite of a liquid nonaqueous electrolyte and a polymeric material. Examples of the polymeric material include polyvinylidene fluoride (PVDF), polyacrylonitrile (PAN), polyethylene oxide (PEO), and mixtures thereof.

Alternatively, besides the nonaqueous liquid electrolyte and the nonaqueous gel electrolyte, a room-temperature molten salt (ionic melt, normal temperature molten salt) containing lithium ions, a polymer solid electrolyte, an inorganic solid electrolyte, and the like may also be used as the nonaqueous electrolyte.

The room temperature molten salt indicates compounds among organic salts made of combinations of organic cations and anions, which are able to exist in a liquid state at room temperature (15° C. to 25° C.). The room temperature molten salt includes a room temperature molten salt which exists alone as a liquid, a room temperature molten salt which becomes a liquid upon mixing with an electrolyte salt, a room temperature molten salt which becomes a liquid when dissolved in an organic solvent, and mixtures thereof. In general, the melting point of the room temperature molten salt used in secondary batteries is 25° C. or below. The organic cations generally have a quaternary ammonium framework.

A polymer solid electrolyte is prepared by dissolving an electrolyte salt into a polymer material and solidifying the result.

The inorganic solid electrolyte is a solid substance having Li-ion conductivity. Herein, having Li-ion conductivity means showing a lithium ion conductivity of 1×10⁻¹⁰ S/cm or more at 25° C. An inorganic solid electrolyte is, for example, an oxide-based solid electrolyte or a sulfide-based solid electrolyte. Specific examples of the inorganic solid electrolyte are described below.

A lithium phosphate solid electrolyte having a NASICON (sodium (Na) super ionic conductor)-type structure and represented by a general formula Li₁₊ₓMα₂(PO₄)₃ is preferably used as the oxide-based solid electrolyte. Mα in the above general formula is, for example, at least one selected from the group consisting of titanium (Ti), germanium (Ge), strontium (Sr), zirconium (Zr), tin (Sn), aluminum (Al), and calcium (Ca). The subscript x in the above general formula is in a range of 0≤x≤2.

Specific examples of the lithium phosphate solid electrolyte having a NASICON-type structure include: LATP compounds represented by Li₁₊ₓAlₓTi₂₋ₓ(PO₄)₃, where 0.1≤x≤0.5; compounds represented by Li₁₊ₓAl_{y}Mβ_{2-y}(PO₄)₃, where MB is at least one selected from the group consisting of Ti, Ge, Sr, Zr, Sn, and Ca, and 0≤x≤1 and 0≤y≤1; compounds represented by Li₁₊ₓAlₓGe₂₋ₓ(PO₄)₃, Where 0≤x≤2; compounds represented by Li₁₊ₓAlₓZr₂₋ₓ(PO₄)₃, where 0≤x≤2; compounds represented by Li_{1+x+y}AlₓMγ₂₋ₓSi_{y}P_{3-y}O₁₂, where My is at least one selected from the group consisting of Ti and Ge, and 0<x≤2, 0≤y<3; and compounds represented by Li₁₊₂ₓZr₁₋ₓCaₓ(PO₄)₃, where 0≤x<1.

Examples of the oxide-based solid electrolyte also include the following in addition to the above lithium phosphate solid electrolytes: amorphous LIPON compounds represented by LiₓPO_{y}N_{z}, where 2.6≤x≤3.5, 1.9≤y≤3.8, and 0.1≤z≤1.3 (e.g., Li_{2.9}PO_{3.3}N_{0.46}); compounds having a garnet structure and represented by La₅₊ₓAₓLa₃₋ₓMδ₂O₁₂, where A is at least one selected from the group consisting of Ca, Sr, and Ba, Md is at least one selected from the group consisting of Nb and Ta, and 0≤x≤0.5; compounds represented by Li₃Mδ₂₋ₓL₂O₁₂, where Mδ is at least one selected from the group consisting of Nb and Ta, L may include Zr, and 0≤x≤0.5; compounds represented by Li₇₋₃ₓAlₓLa₃Zr₃O₁₂, where 0≤x≤0.5; LLZ compounds represented by Li₅₊ₓLa₃Mδ₂₋ₓZrₓO₁₂, where Md is at least one selected from the group consisting of Nb and Ta, and 0≤x≤2 (e.g., Li₇La₃Zr₂O₁₂); and compounds having a perovskite structure and represented by La_{2/3-x}LiₓTiO₃, where 0.3≤x≤0.7.

One or more of the above compounds may be used as the solid electrolyte. Two or more of the above solid electrolytes may be used.

### 4) Separator

The separator is formed of, for example, a porous film containing polyethylene (polyethylene; PE), polypropylene (polypropylene; PP), cellulose, or polyvinylidene fluoride (PVdF), or a synthetic resin nonwoven fabric. From the viewpoint of safety, it is preferable to use a porous film formed from polyethylene or polypropylene. This is because these porous films can be melted at a predetermined temperature to interrupt the current.

### 5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal case is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), square, cylinder, coin, or button-shaped. The container member may be appropriately selected depending on battery size and use of the battery.

### 6) Negative Electrode Terminal

The negative electrode terminal can be formed from a material which is electrically stable in a potential range of 1 V or more and 3 V or less with respect to the oxidation-reduction potential of lithium (vs. Li/Li⁺), and has conductivity. Specific examples of the material for the negative electrode terminal include copper, nickel, stainless steel, aluminum, and aluminum alloy containing at least one element selected from the group consisting of Mg, Ti, Zn, Mn, Fe, Cu, and Si. Aluminum or aluminum alloy is preferred as the material for the negative electrode terminal. The negative electrode terminal is preferably made of the same material as the negative electrode current collector, in order to reduce the contact resistance with the negative electrode current collector.

### 7) Positive Electrode Terminal

The positive electrode terminal can be formed from a material which is electrochemically stable at a Li insertion/extraction potential of the positive electrode active material, and has conductivity. For example, the positive electrode terminal can be formed from a material which is electrically stable in a potential range of 3.0 V or more and 4.7 V or less with respect to the oxidation-reduction potential of lithium (vs. Li/Li⁺). Specific examples of the material of the positive electrode terminal include aluminum, and aluminum alloys containing at least one element selected from the group consisting of Mg, Ti, Zn, Mn, Fe, Cu, and Si. The positive electrode terminal is preferably made of the same material as the positive electrode current collector, in order to reduce the contact resistance with the positive electrode current collector.

Next, the secondary battery according to the embodiment will be described in detail with reference to the drawings.

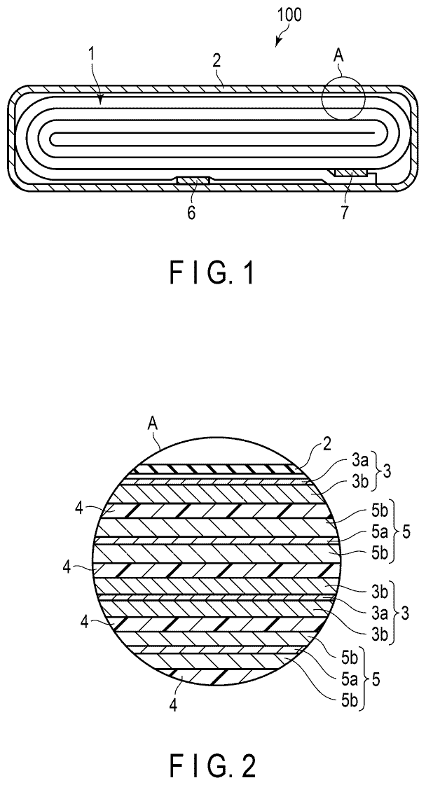

FIG. 1 is a sectional view schematically showing one example of a secondary battery according to an embodiment. FIG. 2 is an enlarged sectional view of a portion A of the secondary battery shown in FIG. 1.

The secondary battery 100 shown in FIG. 1 and FIG. 2 includes a bag-shaped container member 2 shown in FIG. 1, an electrode group 1 shown in FIG. 1 and FIG. 2, and an electrolyte (not shown). The electrode group 1 and the electrolyte are stored in the bag-shaped container member 2. The electrolyte (not shown) is held in the electrode group 1.

The bag-shaped container member 2 is formed from a laminate film including two resin layers and a metal layer disposed therebetween.

As shown in FIG. 1, the electrode group 1 is a flat wound electrode group. The flat wound electrode group 1 includes negative electrodes 3, separators 4, and positive electrodes 5 as shown in FIG. 2. The separator 4 is disposed between the negative electrode 3 and the positive electrode 5.

A negative electrode 3 includes a negative electrode current collector 3a and negative electrode active material-containing layers 3b. In the portion of the negative electrode 3 located at the outermost shell of a wound electrode group 1, the negative electrode active material-containing layer 3b is formed only on the inside surface side of the negative electrode current collector 3a, as shown in FIG. 2. In another portion of the negative electrode 3, the negative electrode active material-containing layer 3b is formed on both sides of the negative electrode current collector 3a.

A positive electrode 5 includes a positive electrode current collector 5a and a positive electrode active material-containing layer 5b formed on both sides thereof.

As shown in FIG. 1, a negative electrode terminal 6 and a positive electrode terminal 7 are positioned near the outer end of the wound electrode group 1. The negative electrode terminal 6 is connected to the outermost part of the negative electrode current collector 3a. In addition, the positive electrode terminal 7 is connected to the outermost part of the positive electrode current collector 5a. The negative electrode terminal 6 and the positive electrode terminal 7 extend outward from opening portions of the bag-shaped container member 2. A thermoplastic resin layer is provided on the inner surface of the bag-shaped container member 2, and the opening of the bag-shaped container member 2 are closed by thermal fusion bonding of the thermoplastic resin layer.

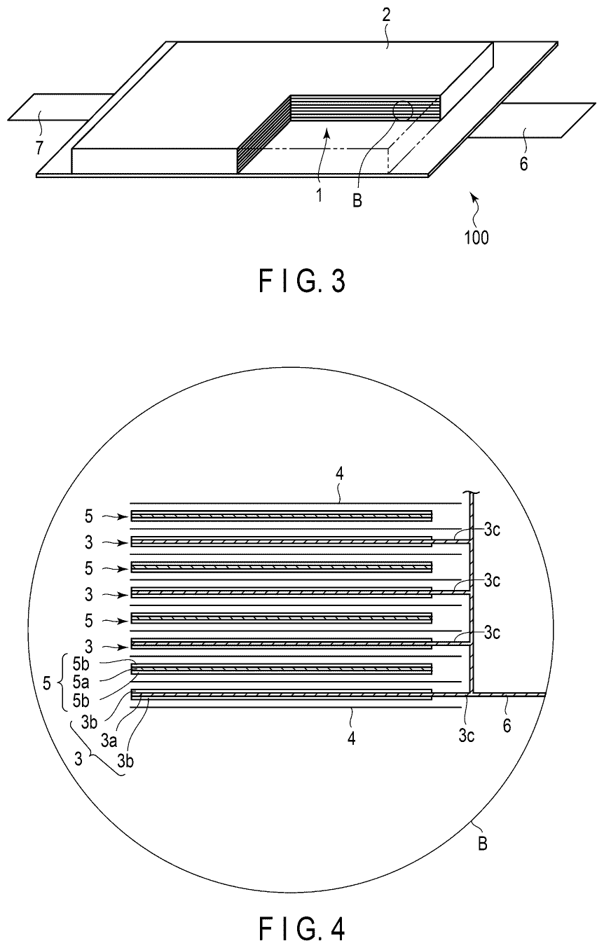

The secondary battery according to the embodiment is not limited to the secondary battery having the structure shown in FIGS. 1 and 2, and may be, for example, a battery having a structure shown in FIGS. 3 and 4.

FIG. 3 is a partial cut-away sectional perspective view schematically showing another example of the secondary battery according to the embodiment. FIG. 4 is an enlarged sectional view of a portion B of the secondary battery shown in FIG. 3.

The secondary battery 100 shown in FIGS. 3 and 4 includes an electrode group 1 shown in FIGS. 3 and 4, a container member 2 shown in FIG. 3, and an electrolyte (not shown). The electrode group 1 and the electrolyte are stored in the container member 2. The electrolyte is held in the electrode group 1.

The container member 2 is made of a laminate film including two resin layers and a metal layer intervening therebetween.

As shown in FIG. 4, the electrode group 1 is a laminated electrode group. The laminated electrode group 1 has a structure in which a negative electrode 3 and a positive electrode 5 are alternately laminated with a separator 4 intervening therebetween.

The electrode group 1 includes a plurality of the negative electrodes 3. The plurality of negative electrodes 3 are each provided with a negative electrode current collector 3a and a negative electrode active material-containing layer 3b carried on both sides of the negative electrode current collector 3a. Further, the electrode group 1 includes a plurality of the positive electrodes 5. The plurality of positive electrodes 5 are each provided with a positive electrode current collector 5a and a positive electrode active material-containing layer 5b carried on both sides of the positive electrode current collector 5a.

The negative electrode current collector 3a of each negative electrode 3 includes a portion on one side where the negative electrode active material-containing layer 3b is not carried on any surfaces. This portion acts as a negative electrode tab 3c. As shown in FIG. 4, negative electrode tab 3c does not overlap the positive electrode 5. In addition, a plurality of negative electrode tabs 3c is electrically connected to a belt-shaped negative electrode terminal 6. A tip of the belt-shaped negative electrode terminal 6 is drawn outward from a container member 2.

Although not shown, the positive electrode current collector 5a of each positive electrode 5 includes, on one side thereof, a portion where the positive electrode active material-containing layer 5b is not supported on any surface (not shown). This portion can serve as a positive electrode current-collecting tab. Like the negative electrode current-collecting tab 3c, the positive electrode current-collecting tab does not overlap the negative electrode 3. The positive electrode current-collecting tab is located on a side opposite to the electrode group 1 with respect to the negative electrode current-collecting tab 3c. The positive electrode current-collecting tab is electrically connected to a belt-shaped positive electrode terminal 7. The tip of the belt-shaped positive electrode terminal 7 is located on a side opposite to the negative electrode terminal 6, and drawn out of the container member 2.

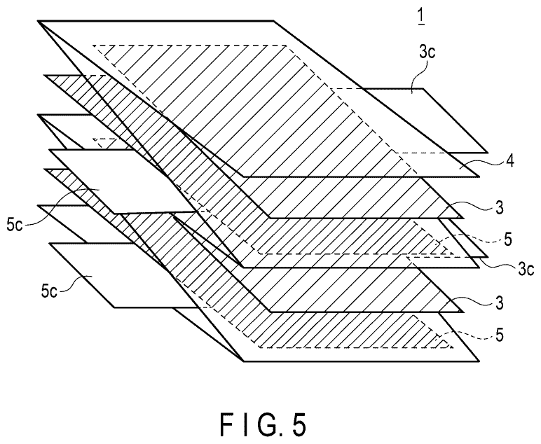

In the battery shown in FIGS. 1 to 4, an electrode group illustrated in FIG. 5 may be used instead of the electrode group described above. The electrode group 1 shown in FIG. 5 is formed by folding the separator 4 in a zigzag pattern, and alternately arranging the negative electrode 3 and the positive electrode 5 at the folding portions. Specifically, the negative electrode 3, the positive electrode 5, the negative electrode 3 and the positive electrode 5 are arranged in the stated order in a state of being sandwiched between separator 4 folded in a zigzag pattern. The negative electrode current-collecting tab 3c protrudes from one long-side portion of the separator 4 folded in a zigzag pattern. The positive electrode current-collecting tab 5c protrudes from the other long-side portion of the separator 4 folded in a zigzag pattern.

The order of the negative electrode 3 and the positive electrode 5 is not limited to the order shown in FIG. 5, and the positive electrode 5, the negative electrode 3, the positive electrode 5, and the negative electrode 3 may be arranged in this order.

The secondary battery according to the second embodiment includes the electrode according to the first embodiment. Thus, in the secondary battery, the discharge rate performance can be improved.

### Third Embodiment

According to the third embodiment, a battery module is provided. The battery module according to the third embodiment is equipped with a plurality of the secondary batteries according to the second embodiment.

In the battery module according to the embodiment, individual unit cells may be electrically connected in series or in parallel, or may be arranged in combination of series connection and parallel connection.

Next, an example of the battery module according to the embodiment will be described with reference to the drawings.

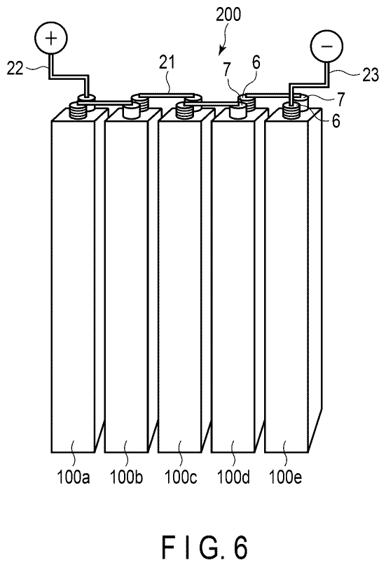

FIG. 6 is a perspective view schematically showing an example of the battery module according to the embodiment. The battery module 200 shown in FIG. 6 includes five unit cells 100a to 100e, four bus bars 21, a positive electrode-side lead 22, and a negative electrode-side lead 23. Each of the five unit cells 100a to 100e is the secondary battery according to the second embodiment.

The busbar 21 connects a negative electrode terminal 6 of a single unit cell 100a to a positive electrode terminal 7 of an adjacently positioned unit cell 100b. In this way, the five unit cells 100a to 100e are connected in series by the four bus bars 21. That is, the battery module 200 shown in FIG. 6 is a battery module of five in-series connection. Although an example is not illustrated, in a battery module containing a plurality of unit cells electrically connected in parallel, the plurality of unit cells may be electrically connected by connecting the plurality of negative electrode terminals to each other with busbars and also connecting the plurality of positive electrode terminals to each other with busbars, for example.

The positive electrode terminal 7 of at least one battery among the five unit cells 100a to 100e is electrically connected to a positive electrode lead 22 for external connection. Also, the negative electrode terminal 6 of at least one battery among the five unit cells 100a to 100e is electrically connected to a negative electrode lead 23 for external connection.

The battery module according to the third embodiment includes the secondary battery according to the second embodiment. Therefore, the discharge rate performance can be improved.

### Fourth Embodiment

According to the fourth embodiment, a battery pack is provided. The battery pack includes the battery module according to the third embodiment. The battery pack may also be equipped with a single secondary battery according to the second embodiment instead of the battery module according to the third embodiment.

The battery pack according to the embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the embodiment may further include an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of a motive force of vehicles such as automobiles) is provided to the battery pack via the external power distribution terminal.

Next, an example of a battery pack according to the embodiment will be described with reference to the drawings.

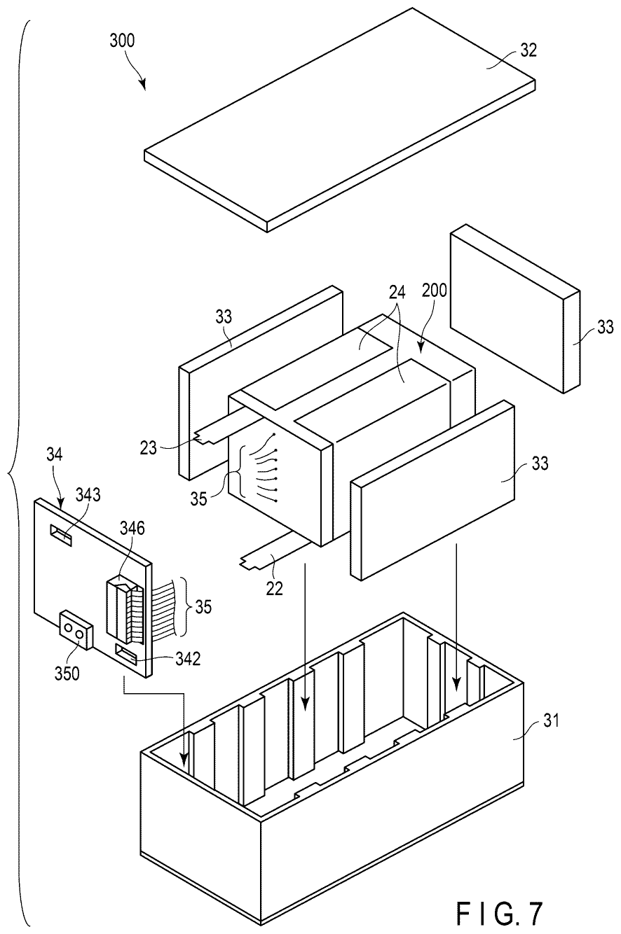

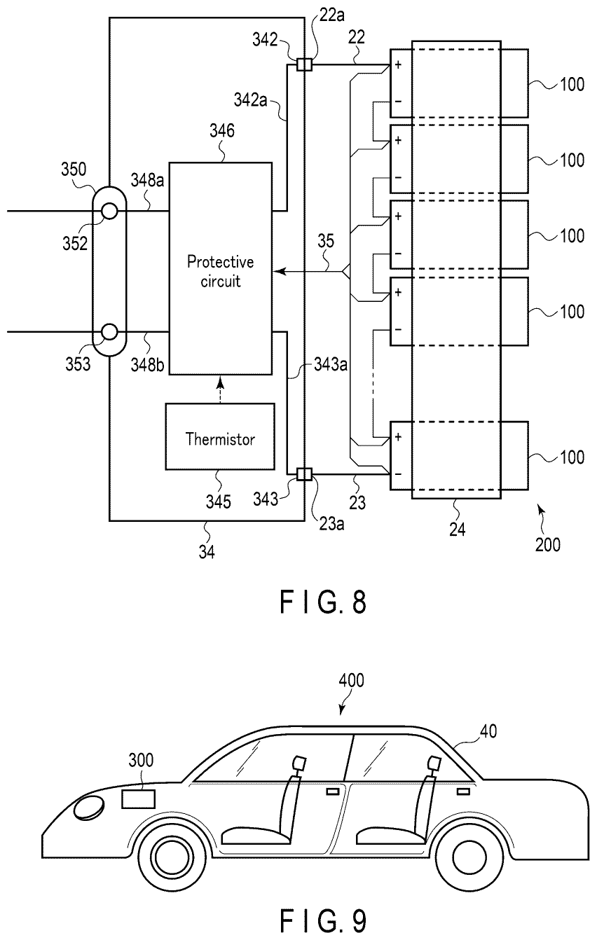

FIG. 7 is an exploded perspective view schematically showing an example of the battery pack according to the embodiment. FIG. 8 is a block diagram showing an example of an electric circuit of the battery pack shown in FIG. 7.

A battery pack 300 shown in FIGS. 7 and 8 includes a housing container 31, a lid 32, protective sheets 33, a battery module 200, a printed wiring board 34, wires 35, and an insulating plate (not shown).

A housing container 31 shown in FIG. 7 is a bottomed-square-shaped container having a rectangular bottom surface. The housing container 31 is configured to house protective sheet 33, a battery module 200, a printed wiring board 34, and wires 35. A lid 32 has a rectangular shape. The lid 32 covers the housing container 31 to house the battery module 200 and the like. Although not shown, opening(s) or connection terminal(s) for connecting to external device(s) and the like are provided on the housing container 31 and lid 32.

The battery module 200 includes plural unit cells 100, a positive electrode-side lead 22, a negative electrode-side lead 23, and an adhesive tape 24.

At least one in the plurality of unit cells 100 is a secondary battery according to the second embodiment. Each unit cell 100 in the plurality of unit cells 100 is electrically connected in series, as shown in FIG. 8. The plurality of unit cells 100 may alternatively be electrically connected in parallel, or connected in a combination of in-series connection and in-parallel connection. If the plurality of unit cells 100 is connected in parallel, the battery capacity increases as compared to a case where they are connected in series.

The adhesive tape 24 fastens the plural unit cells 100. The plural unit cells 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural unit cells 100.

One terminal of a positive electrode lead 22 is connected to a battery module 200. One terminal of the positive electrode lead 22 is electrically connected to the positive electrode of one or more unit cells 100. One terminal of a negative electrode lead 23 is connected to the battery module 200. One terminal of the negative electrode lead 23 is electrically connected to the negative electrode of one or more unit cells 100.

The printed wiring board 34 is arranged on the inner surface of the housing container 31 along the short side direction. The printed wiring board 34 includes a positive electrode connector 342, a negative electrode connector 343, a thermistor 345, a protective circuit 346, wirings 342a and 343a, an external power distribution terminal 350, a plus-side wire (positive-side wire) 348a, and a minus-side wire (negative-side wire) 348b. One principal surface of the printed wiring board 34 faces one side surface of the battery module 200. An insulating plate (not shown) is disposed in between the printed wiring board 34 and the battery module 200.

The other terminal 22a of the positive electrode lead 22 is electrically connected to a positive electrode connector 342. The other terminal 23a of the negative electrode lead 23 is electrically connected to a negative electrode connector 343.

The thermistor 345 is fixed to one principal surface of the printed wiring board 34. The thermistor 345 detects the temperature of each unit cell 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive side terminal 352 and a negative side terminal 353.

The protective circuit 346 is fixed to the other principal surface of the printed wiring board 34. The protective circuit 346 is connected to the positive side terminal 352 via the plus-side wire 348a. The protective circuit 346 is connected to the negative side terminal 353 via the minus-side wire 348b. In addition, the protective circuit 346 is electrically connected to the positive electrode connector 342 via the wiring 342a. The protective circuit 346 is electrically connected to the negative electrode connector 343 via the wiring 343a. Furthermore, the protective circuit 346 is electrically connected to each unit cell 100 in the plurality of unit cells 100 via the wires 35.

The protective sheets 33 are arranged on both inner surfaces of the housing container 31 along the long side direction and on one inner surface of the housing container 31 along the short side direction facing the printed wiring board 34 through the battery module 200. The protective sheet 33 is made of, for example, resin or rubber.

The protective circuit 346 controls charging and discharging of the plurality of unit cells 100. The protective circuit 346 is also configured to cut off electric connection between the protective circuit 346 and the external power distribution terminal 350 (the positive side terminal 352 and the negative side terminal 353) to the external devices, based on detection signals transmitted from the thermistor 345 or detection signals transmitted from each unit cell 100 or the battery module 200.

An example of the detection signal transmitted from the thermistor 345 is a signal indicating that the temperature of the unit cell(s) 100 is detected to be a predetermined temperature or more. An example of the detection signal transmitted from each unit cell 100 or the battery module 200 is a signal indicating detection of over-charge, over-discharge, and overcurrent of the unit cell(s) 100. When detecting over-charge or the like for each of the unit cells 100, the battery voltage may be detected, or a positive electrode potential or negative electrode potential may be detected. In the latter case, a lithium electrode to be used as a reference electrode may be inserted into each unit cell 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include a plurality of battery modules 200. In this case, the plurality of battery modules 200 may be connected in series, in parallel, or connected in a combination of in-series connection and in-parallel connection. The printed wiring board 34 and the wires 35 may be omitted. In this case, the positive electrode lead 22 and the negative electrode lead 23 may be used as the positive side terminal 352 and the negative side terminal 353 of the external power distribution terminal 350, respectively.

Such a battery pack is used for, for example, an application required to have the excellent cycle performance when a large current is taken out. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

The battery pack according to the fourth embodiment includes the secondary battery according to the second embodiment or the battery module according to the third embodiment. Therefore, the discharge rate performance can be improved.

### Fifth Embodiment

According to a fifth embodiment, a vehicle is provided. The vehicle is equipped with the battery pack according to the fourth embodiment.

In the vehicle, the battery pack recovers, for example, regenerative energy of power of the vehicle. The vehicle may include a mechanism (regenerator) that converts kinetic energy of the vehicle into regenerative energy.

Examples of the vehicle according to the fifth embodiment include two- to four-wheeled hybrid electric automobiles, two- to four-wheeled electric automobiles, electric assist bicycles, and railway cars.

In the vehicle according to the fifth embodiment, the installing position of the battery pack is not particularly limited. For example, the battery pack may be installed in the engine compartment of the vehicle, in rear parts of the vehicle, or under seats.

A plurality of battery packs is loaded on the vehicle according to the fifth embodiment. In this case, the batteries included in each of the battery packs may be electrically connected to each other in series, in parallel, or in a combination of in-series connection and in-parallel connection. For example, in the case where each battery pack includes a battery module, the battery modules may be electrically connected to each other in series, in parallel, or in a combination of in-series connection and in-parallel connection. Alternatively, in the case where each battery pack includes a single battery, each of the batteries may be electrically connected to each other in series, in parallel, or in a combination of in-series connection and in-parallel connection.

Next, one example of the vehicle according to the fifth embodiment will be described with reference to the

### DRAWINGS

FIG. 9 is a partially transparent diagram schematically illustrating one example of a vehicle according to the embodiment.

A vehicle 400 illustrated in FIG. 9 includes a vehicle body 40 and a battery pack 300 according to the embodiment. In the example illustrated in FIG. 9, the vehicle 400 is a four-wheeled automobile.

A plurality of the battery packs 300 may be loaded on the vehicle 400. In this case, the batteries included in the battery packs 300 (for example, unit cell or battery modules) may be connected in series, connected in parallel, or connected in a combination of in-series connection and in-parallel connection.

In FIG. 9, the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

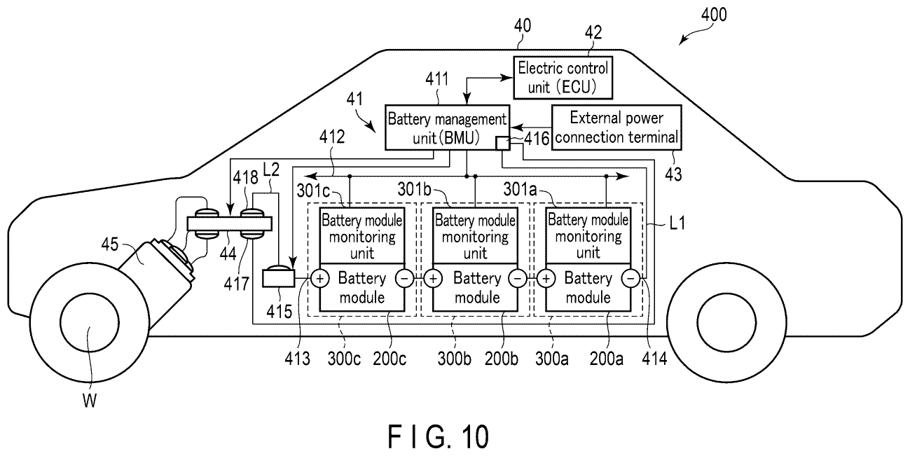

Next, an embodiment of the vehicle according to the fifth embodiment will be described with reference to FIG. 10.

FIG. 10 is a diagram schematically illustrating one example of a control system related to an electrical system in the vehicle according to the fifth embodiment. The vehicle 400 illustrated in FIG. 10 is an electric automobile.

The vehicle 400, shown in FIG. 10, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 10, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

A battery pack 300a is provided with a battery module 200a and a battery module monitoring unit 301a (for example, voltage temperature monitoring (VTM)). A battery pack 300b is provided with a battery module 200b and a battery module monitoring unit 301b. A battery pack 300c is provided with a battery module 200c and a battery module monitoring unit 301c. The battery packs 300a to 300c are battery packs similar to the battery pack 300 described earlier, and the battery modules 200a to 200c are battery modules similar to the battery module 200 described earlier. The battery modules 200a to 200c are electrically connected in series. The battery packs 300a, 300b, and 300c are removable independently of each other, and each can be replaced with a different battery pack 300.

Each of the battery modules 200a to 200c includes plural battery cells connected in series. At least one of the plural battery cells is the secondary battery according to the second embodiment. The battery modules 200a to 200c each perform charging and discharging via a positive electrode terminal 413 and a negative electrode terminal 414.

A battery management unit 411 communicates with the battery module monitoring unit 301a to 301c, and collects information related to the voltage, temperature, and the like for each of the unit cells 100 included in the battery modules 200a to 200c included in the vehicle power source 41. With this arrangement, the battery management unit 411 collects information related to the maintenance of the vehicle power source 41.

The battery management unit 411 and the battery module monitoring unit 301a to 301c are connected via a communication bus 412. In the communication bus 412, a set of communication wires are shared with a plurality of nodes (the battery management unit 411 and one or more of the battery module monitoring unit 301a to 301c). The communication bus 412 is a communication bus, for example, configured in accordance with the controller area network (CAN) standard.

The battery module monitoring units 301a to 301c measure a voltage and a temperature of each battery cell in the battery modules 200a to 200c based on commands from the battery management unit 411. It is possible, however, to measure the temperatures only at several points per battery module, and the temperatures of all of the battery cells need not be measured.

The vehicle power source 41 can also have an electromagnetic contactor (for example, a switch apparatus 415 illustrated in FIG. 10) that switches the presence or absence of an electrical connection between a positive electrode terminal 413 and a negative electrode terminal 414. The switch apparatus 415 includes a pre-charge switch (not illustrated) that turns on when the battery modules 200a to 200c are charged, and a main switch (not illustrated) that turns on when the output from the battery modules 200a to 200c is supplied to the load. Each of the pre-charge switch and the main switch is provided with a relay circuit (not illustrated) that switches on or off according to a signal supplied to a coil disposed near a switching element. The electromagnetic contactor such as the switch apparatus 415 is controlled according to of control signals from the battery management unit 411 or the vehicle ECU 42 that controls the entire operation of the vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411, or the vehicle ECU 42 which controls the entire operation of the vehicle. By controlling the inverter 44, the output voltage from the inverter 44 is adjusted.

The drive motor 45 is rotated by electric power supplied from the inverter 44. The driving force produced by the rotation of the drive motor 45 is transmitted to an axle (or axles) and drive wheels W via a differential gear unit for example.

The vehicle 400 also includes a regenerative brake mechanism (regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connection line L1 is connected to the negative electrode terminal 414 of the vehicle power source 41. The other terminal of the connection line L1 is connected to a negative electrode input terminal 417 of the inverter 44. On the connection line L1, a current detector (current detection circuit) 416 is provided inside the battery management unit 411 between the negative electrode terminal 414 and the negative electrode input terminal 417.

One terminal of a connection line L2 is connected to the positive electrode terminal 413 of the vehicle power source 41. The other terminal of the connection line L2 is connected to a positive electrode input terminal 418 of the inverter 44. On the connection line L2, the switch apparatus 415 is provided between the positive electrode terminal 413 and the positive electrode input terminal 418.

The external terminal 43 is connected to the battery management unit 411. The external terminal 43 can be connected to, for example, an external power source. The vehicle ECU 42 cooperatively controls the vehicle power source 41, the switch apparatus 415, the inverter 44, and the like together with other management apparatus and control apparatus, including the battery management unit 411, in response to operation input from a driver or the like. By the cooperative control by the vehicle ECU 42 and the like, the output of electric power from the vehicle power source 41, the charging of the vehicle power source 41, and the like are controlled, and the vehicle 400 is managed as a whole. Data related to the maintenance of the vehicle power source 41, such as the remaining capacity of the vehicle power source 41, is transferred between the battery management unit 411 and the vehicle ECU 42 by a communication line.

The vehicle according to the fifth embodiment is equipped with the battery pack according to the fourth embodiment. Therefore, the discharge rate performance of the battery pack is high, so that a vehicle having high performance can be provided.

### EXAMPLES

Hereinafter, the embodiments will be described in more detail by way of examples.

### Example 1

### (Production of Positive Electrode)

Acetylene black (AB) as a granular carbon material, carbon nanotubes (CNT) as a fibrous carbon material, and a styrene-maleic acid copolymer as a dispersant were prepared. These materials were mixed such that the mass ratio of AB:CNT:dispersant was 1:1:1, thereby obtaining a mixture. Next, the obtained mixture was added to n-methylpyrrolidone (NMP) as a solvent, and dispersed with a bead mill to obtain a dispersion liquid.

Next, FU value adjustment was performed on particles of a lithium nickel cobalt manganese oxide LiNi_{0.6}Co_{0.1}Mn_{0.3}O₂ which is a nickel containing composite oxide having a layered structure, as a positive electrode active material. Specifically, milling was performed with a bead mill for 10 minutes under conditions of a bead diameter of 50 μm and a peripheral speed of 2,000 rpm. FUₐᵥₑ for primary particles of the positive electrode active material before FU value adjustment was 0.66, and FUₐᵥₑ for primary particles of the positive electrode active material after FU value adjustment was 0.72.

Polyvinylidene fluoride (PVdF) as a binder was added to the positive electrode active material after FU value adjustment, and the mixture was stiffened (kneaded) using a planetary mixer. The dispersion liquid was added to the kneaded product thus obtained, and mixing was performed with a jet paster to prepare a slurry. Here, the slurry was prepared such that the mass ratio of the positive electrode active material, the binder, AB, CNT, and the dispersant was 100:5:5:5:5. The slurry was added, and dispersion was performed for 30 minutes with a jet paster to obtain a positive electrode slurry. Dispersion conditions were set such that the number of revolutions was 3,000 rpm, the degree of pressure reduction was-0.1 MPa, and the flow rate was 1,000 L/h.

An Al foil having a thickness of 12 μm was provided as a positive electrode current collector. The rectangular positive electrode current collector used had two opposite long sides and two opposite short sides. The slurry obtained as described above was applied to the positive electrode current collector to form a coating film. Here, an uncoated portion free of the slurry was provided on one end portion of the positive electrode current collector in the long side direction, that is, one of the short sides of the positive electrode current collector. The coating film formed as described above was dried to obtain a positive electrode active material-containing layer. The positive electrode was thus obtained.

### Examples 2 and 3

Except that the average primary particle size of the positive electrode active material, the average fiber length of the fibrous carbon material, and the average primary particle size of the granular carbon material were changed to values shown in Tables 1 and 3, the same procedure as in Example 1 was carried out to produce positive electrodes.

### Example 4

The average primary particle size of the positive electrode active material, the average fiber length of the fibrous carbon material, and the average primary particle size of the granular carbon material were changed to values shown in Tables 1 and 3. In addition, the bead milling conditions during FU value adjustment were changed to 5 minutes under conditions of a bead diameter of 50 μm and a peripheral speed of 1,000 rpm. Except for the above, the same procedure as in Example 1 was carried out to produce a positive electrode.

### Examples 5 to 12

The composition of the nickel containing composite oxide having a layered structure as a positive electrode active material was changed to types shown in Table 2. The average primary particle size of the positive electrode active material, the average fiber length and the average fiber diameter of the fibrous carbon material, and the average primary particle size of the granular carbon material were changed to values shown in Tables 1 and 3. Except for the above, the same procedure as in Example 1 was carried out to produce a positive electrode.

### Example 15

Except that the average fiber length of the fibrous carbon material, and the average primary particle size of the granular carbon material were changed to values shown in Tables 1 and 3, the same procedure as in Example 1 was carried out to produce a positive electrode.

### Example 16

The average fiber length of the fibrous carbon material was changed to a value shown in Table 1. In addition, the granular carbon material was not blended, and the mixing ratio of the materials in preparation of the slurry was set such that the mass ratio of the positive electrode active material:the binder:the CNT:the dispersant was 100:5:1:2. Except for the above, the same procedure as in Example 1 was carried out to produce a positive electrode.

### Comparative Example 1

The average fiber length of the fibrous carbon material, and the average primary particle size of the granular carbon material were changed to values shown in Tables 1 and 3. In addition, FU value adjustment was omitted. Except for the above, the same procedure as in Example 1 was carried out to produce a positive electrode.

### Comparative Example 2

The average fiber length of the fibrous carbon material, and the average primary particle size of the granular carbon material were changed to values shown in Tables 1 and 3. In addition, FU value adjustment was omitted, and mixing of a kneaded product and a dispersion liquid in slurry preparation was performed with a bead mill instead of a jet paster. The bead milling condition was set to 40 minutes under conditions of a bead diameter of 500 μm and a peripheral speed of 6,000 rpm. Except for the above, the same procedure as in Example 1 was carried out to produce a positive electrode.

For the electrodes of examples and comparative examples described above, the average primary particle size (μm) of the positive electrode active material, the average value FUₐᵥₑ of the coefficient of form unevenness FU for primary particles containing a nickel containing composite oxide having a layered structure, the composition of the positive electrode active material, the relative amount x of nickel, the relative amount y of cobalt and the relative amount z of manganese where the total amount of nickel, cobalt, and manganese in the primary particles is assumed to be 10, the average outer peripheral length lₐᵥₑ (μm) of a primary particles containing a nickel containing composite oxide having a layered structure, the average fiber length Lₐᵥₑ (μm) of the fibrous carbon material, lₐᵥₑ/Lₐᵥₑ, the average primary particle size r′ (μm) of the granular carbon material, and the average fiber diameter r (μm), and r′/r were measured by the methods described above. The measurement results are collectively shown in Tables 1 to 3 below. Note that r′ (μm) and r′/r for Example 16 in which the granular carbon material is not blended are indicated by “-”.

Further, for evaluation of the performance of the electrode, a battery was produced in the following manner using each of examples and comparative examples as a positive electrode.

### (Production of Negative Electrode)

As a negative electrode active material, Li₄Ti₅O₁₂ particles having an average particle size of 0.6 μm and a specific surface area of 10 m²/g were provided. As an electro-conductive agent, graphite powder having an average particle size of 6 μm was provided. PVdF was provided as a binder.

A slurry was prepared by dispersing 95% by mass of a negative electrode active material, 3% by mass of a graphite powder, and 2% by mass of PVdF in a n-methylpyrrolidone (NMP) solvent, and then stirring the dispersion at a rotation speed of 1,000 rpm for 2 hours using a ball mill.

A Cu foil having a thickness of 10 μm was provided as a negative electrode current collector. The rectangular negative electrode current collector used had two opposite long sides and two opposite short sides. The slurry obtained as described above was applied to the negative electrode current collector to form a coating film. Here, an uncoated portion free of the slurry was provided on one end portion of the negative electrode current collector in the long side direction, that is, one of the short sides of the negative electrode current collector. The coating film formed as described above was dried to obtain a negative electrode active material-containing layer. A negative electrode was thus obtained.

### (Assembly of Electrode Group)

A polyethylene (PE) separator having a thickness of 15 μm was provided. The separator was folded in a zigzag pattern, and the negative electrode and the positive electrode were arranged in spaces formed between the separator to obtain a stack. Specifically, six negative electrodes and five positive electrodes were alternately arranged from the negative electrode with the separator between the negative electrode and the positive electrode. The positive electrode and the negative electrode were stacked such that their uncoated portions were located, respectively, on opposite sides of the stack, and the positive electrode and the negative electrode faced each other with the separator interposed therebetween. A portion of the main surface of each electrode, which faced an opposite electrode, had a size of 50 mm in length and 50 mm in width. A stack including a positive electrode, a negative electrode, and a separator was thus obtained.

The stack was pressed by applying a load of 80 kN at room temperature (25° C.) for 1 minute. An electrode group was thus produced.

### (Preparation of Nonaqueous Electrolyte)

A nonaqueous electrolyte was prepared by the following procedure. First, propylene carbonate (PC) and diethyl carbonate (DEC) were mixed such that the volume ratio of PC and DEC was 1:2, thereby obtaining a mixed solvent. Lithium hexafluorophosphate LiPF₆ was dissolved in the mixed solvent at a concentration of 1M (mol/L) to obtain a liquid nonaqueous electrolyte.

### (Assembly of Battery)

The electrode group was housed in a pack as a container member which was made from a laminate film. Here, one side of the container member was opened. As the laminate film, a laminate film, which had a total thickness of 0.1 mm and in which a polypropylene layer was formed on both surfaces of an aluminum foil having a thickness of 40 μm, was used. Vacuum drying was performed at 80° C. for 10 hours with the electrode group housed in the container member. After vacuum drying, a nonaqueous electrolyte was injected into the container member. After injection, the opened side of the container member was heat-sealed under reduced pressure to perform sealing. A battery was thus produced.

### (Performance Test)

A performance test for a battery produced as above using the positive electrode of each of examples and comparative examples was conducted as follows.

The battery was discharged at 0.2 C and 5 C, and a ratio of a discharge capacity at 5 C to a capacity at 0.2 C (5 C/0.2 C capacity ratio) was determined as an index of rate performance.

The resistance of the battery at 0.5 Hz in SOC of 50% (2.25 Vvs Li/Li⁺) was measured, and taken as the initial resistance. Next, a charge-discharge test was performed 1,000 cycles at 25° C. and a time rate of 3 C, and a ratio of the resistance at 0.5 Hz at the 1,000th cycle to the initial resistance at the 1st cycle (0.5 Hz resistance ratio) was determined.

The 5 C/0.2 C discharge capacity ratio and the 0.5 Hz resistance ratio which are measured as described above are shown in Table 3.

TABLE 1

| | Average | | | | |
|---|---|---|---|---|---|
| | primary | | | | |
| | particle | | | | |
| | diameter | | lₐᵥₑ | Lₐᵥₑ | lₐᵥₑ/ |
| | (μm) | FUₐᵥₑ | (μm) | (μm) | Lₐᵥₑ |
| Example 1 | 4.0 | 0.72 | 12.5 | 6.4 | 2.0 |
| Example 2 | 0.1 | 0.72 | 0.33 | 5.2 | 0.1 |
| Example 3 | 10.0 | 0.72 | 31.0 | 6.4 | 4.8 |
| Example 4 | 1.0 | 0.70 | 3.4 | 5.2 | 0.7 |
| Example 5 | 3.0 | 0.72 | 12.8 | 5.0 | 2.6 |
| Example 6 | 3.0 | 0.72 | 14.0 | 4.8 | 2.9 |
| Example 7 | 3.4 | 0.72 | 13.8 | 5.2 | 2.7 |
| Example 8 | 6.0 | 0.72 | 18.0 | 4.7 | 3.8 |
| Example 9 | 4.8 | 0.72 | 15.0 | 6.4 | 2.3 |
| Example 10 | 4.0 | 0.72 | 13.2 | 3.0 | 4.4 |
| Example 11 | 3.8 | 0.72 | 12.5 | 5.1 | 2.5 |
| Example 12 | 4.0 | 0.72 | 12.5 | 3.0 | 4.2 |
| Example 15 | 4.0 | 0.72 | 12.5 | 4.9 | 2.6 |
| Example 16 | 4.0 | 0.72 | 12.5 | 4.0 | 3.1 |
| Comparative Example 1 | 4.0 | 0.63 | 21.0 | 3.8 | 5.5 |
| Comparative Example 2 | 4.0 | 0.53 | 24.0 | 3.8 | 6.3 |

TABLE 2

| | Positive electrode | | | | |
|---|---|---|---|---|---|
| | active material | | | | |
| | composition | x | y | z | z/x |
| Example 1 | LiNi_{0.6}Co_{0.1}Mn_{0.3}O₂ | 6 | 1 | 3 | 0.5 |
| Example 2 | LiNi_{0.6}Co_{0.1}Mn_{0.3}O₂ | 6 | 1 | 3 | 0.5 |
| Example 3 | LiNi_{0.6}Co_{0.1}Mn_{0.3}O₂ | 6 | 1 | 3 | 0.5 |
| Example 4 | LiNi_{0.6}Co_{0.1}Mn_{0.3}O₂ | 6 | 1 | 3 | 0.5 |
| Example 5 | LiNi_{0.74}Co_{0.01}Mn_{0.25}O₂ | 7.4 | 0.1 | 2.5 | 0.33784 |
| Example 6 | LiNi_{0.73}Co_{0.02}Mn_{0.25}O₂ | 7.3 | 0.2 | 2.5 | 0.34247 |
| Example 7 | LiNi_{0.63}Co_{0.06}Mn_{0.31}O₂ | 6.3 | 0.6 | 3.1 | 0.492063 |
| Example 8 | LiNi_{0.5}Co_{0.2}Mn_{0.3}O₂ | 5 | 2 | 3 | 0.6 |
| Example 9 | LiNi_{0.6}Co_{0.2}Mn_{0.2}O₂ | 6 | 2 | 2 | 0.33333 |
| Example 10 | LiNi_{0.57}Co_{0.12}Mn_{0.31}O₂ | 5.7 | 1.2 | 3.1 | 0.54386 |
| Example 11 | LiNi_{0.68}Co_{0.09}Mn_{0.23}O₂ | 6.8 | 0.9 | 2.3 | 0.33824 |
| Example 12 | LiNi_{0.63}Co_{0.16}Mn_{0.21}O₂ | 6.3 | 1.6 | 2.1 | 0.33333 |
| Example 15 | LiNi_{0.6}Co_{0.1}Mn_{0.3}O₂ | 6 | 1 | 3 | 0.5 |
| Example 16 | LiNi_{0.6}Co_{0.1}Mn_{0.3}O₂ | 6 | 1 | 3 | 0.5 |
| Comparative | LiNi_{0.6}Co_{0.1}Mn_{0.3}O₂ | 6 | 1 | 3 | 0.5 |
| Example 1 | | | | | |
| Comparative | LiNi_{0.6}Co_{0.1}Mn_{0.3}O₂ | 6 | 1 | 3 | 0.5 |
| Example 2 | | | | | |

TABLE 3

| | | | | 5 C/0.2 C | |
|---|---|---|---|---|---|
| | | | | Discharge | 0.5 Hz |
| | | | | capacity | Resistance |
| | r′ (μm) | r (μm) | r′/r | ratio | ratio |
| Example 1 | 0.010 | 0.0017 | 6 | 87.3 | 2.1 |
| Example 2 | 0.011 | 0.0017 | 6 | 92 | 2.8 |
| Example 3 | 0.009 | 0.0017 | 5 | 76 | 1.9 |
| Example 4 | 0.012 | 0.0017 | 7 | 79 | 2.0 |
| Example 5 | 0.014 | 0.0023 | 6 | 84 | 3.5 |
| Example 6 | 0.010 | 0.0017 | 6 | 80.4 | 3.2 |
| Example 7 | 0.011 | 0.0017 | 6 | 78 | 2.2 |
| Example 8 | 0.013 | 0.0018 | 7 | 83 | 1.9 |
| Example 9 | 0.010 | 0.0017 | 6 | 86.3 | 1.3 |
| Example 10 | 0.011 | 0.0017 | 6 | 78.2 | 4.3 |
| Example 11 | 0.011 | 0.0018 | 6 | 83 | 2.1 |
| Example 12 | 0.012 | 0.0017 | 7 | 85.9 | 2.0 |
| Example 15 | 0.021 | 0.0017 | 12 | 88 | 2.2 |
| Example 16 | — | 0.0017 | — | 70 | 12 |
| Comparative | 0.011 | 0.0017 | 6 | 54 | 7.0 |
| Example 1 | | | | | |
| Comparative | 0.011 | 0.0017 | 6 | 57 | 5.7 |
| Example 2 | | | | | |

In all of Examples 1 to 16, the 5 C/0.2 C discharge capacity ratio was higher than that in Comparative Examples 1 and 2. Therefore, it has been demonstrated that the electrodes according to the embodiments are excellent in discharge rate performance.

In all of Examples 1 to 3 where the average value lₐᵥₑ of the outer peripheral length l of primary particles containing a nickel containing composite oxide having a layered structure, relative to the average fiber length Lₐᵥₑ of the fibrous carbon material was changed to various values, the 5 C/0.2 C capacity ratio was high and the 0.5 Hz resistance ratio was low. From this, it has been demonstrated that the electrode satisfying lₐᵥₑ/Lₐᵥₑ≤5.0 can improve discharge rate performance and suppress an increase in resistance with a charge-discharge cycle.

Even if a change to various positive electrode active materials was made as in Examples 1, and 5 to 12, the 5 C/0.2 C capacity ratio was high and the 0.5 Hz resistance ratio was low. In addition, in all of Examples, the expressions (3) and (4) described above are satisfied.

z/x≥1/3 Expression (3):

y≤2 Expression (4):

That is, it has been demonstrated that by including primary particles satisfying expressions (3) and (4), both high discharge rate performance and suppression of an increase in resistance with a charge-discharge cycle can be achieved.

In Examples 1 to 15 where the active material-containing layer contained a granular carbon material in which the average primary particle size r′ was not less than 5 times and not more than 12 times of the average fiber diameter r of the fibrous carbon material, the 0.5

Hz resistance ratio was lower than that in Example 16 where a granular carbon material was not contained. By including a granular carbon material in which the average primary particle size r′ is not less than 5 times and not more than 12 times of the average fiber diameter r of the fibrous carbon material, low resistance of the electrode can be maintained even after a charge-discharge cycle.

In Comparative Example 1 where FU value adjustment was omitted, the value of FUₐᵥₑ was as low as 0.63.

In addition, in Comparative Example 2 where a slurry was mixed using a bead mill during preparation of a positive electrode slurry, the value of FUₐᵥₑ was as low as 0.53. For Comparative Example 2, it is considered that FUₐᵥₑ of the particles decreased because mixing was performed using a bead mill having a high shear force in preparation of the positive electrode slurry.

The electrodes of Comparative Examples 1 and 2 in which the FUₐᵥₑ value had a lower 5 C/0.2 C discharge capacity ratio as compared to Examples 1 to 16. That is, the electrodes were poor in discharge rate performance.

In Comparative Examples 1 and 2, a granular carbon material was contained as in Examples 1 to 15, but the 0.5 Hz resistance ratio was high. That is, in Comparative Examples 1 and 2, the effect of suppressing an increase in resistance with a charge-discharge cycle was smaller than that in Examples 1 to 15. This may be because the value of FUₐᵥₑ for primary particles of the nickel containing composite oxide having a layered structure was low, that is, the particle surface has many irregularities and a large surface area, so that side reactions easily occur, and the resistance is likely to increase with a charge-discharge cycle.

According to at least one of the embodiments or examples described above, an electrode is provided. The electrode includes an active material-containing layer containing an active material and a fibrous carbon material. The active material includes a primary particles containing a nickel containing composite oxide having a layered structure. An average particle size of the primary particles is within a range of 0.1 μm or more and 10 μm or less. FUₐᵥₑ of the primary particles is 0.70 or more. The FUₐᵥₑ is an average value of a coefficient of form unevenness FU represented by the following expression (1). In the expression (1), 1 is an outer peripheral length of each of the primary particles in a projected cross-section, and a is an area of the projected cross-section. Thus, an electrode capable of realizing a secondary battery having excellent discharge rate performance can be provided.

$$\begin{matrix}( Math 5 ) & \\ FU = \frac{f}{{f}_{c}} = \frac{4 π a}{{ℓ}^{2}} & ( 1 )\end{matrix}$$

The inventions of the embodiments are appended below.

<1> An electrode comprising
an active material-containing layer containing an active material and a fibrous carbon material,
wherein the active material includes primary particles containing a nickel containing composite oxide having a layered structure,
an average particle size of the primary particles is within a range of 0.1 μm or more and 10 μm or less, and
FUₐᵥₑ of the primary particles is 0.70 or more,
where the FUₐᵥₑ is an average value of a coefficient of form unevenness FU represented by the following expression (1):

$$\begin{matrix}( Math 6 ) & \\ FU = \frac{f}{{f}_{c}} = \frac{4 π a}{{ℓ}^{2}} & ( 1 )\end{matrix}$$

wherein l is an outer peripheral length of each of the primary particles in a projected cross-section, and a is an area of the projected cross-section.

<2> The electrode according to <1>,
wherein the following expression (2) is satisfied:

lₐᵥₑ/Lₐᵥₑ≤5.0, Expression (2):
the Lₐᵥₑ is an average fiber length of the fibrous carbon material, and
the lₐᵥₑ is an average value of the l of the primary particles.

<3> The electrode according to <1> or <2>,
wherein the primary particle containing the nickel containing composite oxide having a layered structure contains nickel, cobalt and manganese,
the electrode satisfies the following expressions (3) and (4):

z/x≥1/3 Expression (3):

y≤2, Expression (4):
the x is a relative amount of the nickel to a total amount of the nickel, the cobalt and the manganese,
the y is a relative amount of the cobalt to the total amount, and
the z is a relative amount of the manganese to the total amount,
where the total amount is assumed to be 10.

<4> The electrode according to any one of <1> to <3>,
wherein the active material-containing layer further contains a granular carbon material, and
an average primary particle size r′ of the granular carbon material is not less than 5 times and not more than 12 times of an average fiber diameter r of the fibrous carbon material.

<5> A secondary battery comprising:
a positive electrode;
a negative electrode; and
an electrolyte,
the positive electrode comprising the electrode according to any one of <1> to <4>.

<6> A battery pack comprising the secondary battery according to <5>.

<7> The battery pack according to <6>, further comprising:
an external power distribution terminal; and
a protective circuit.

<8> The battery pack according to <6> or <7>, comprising a plurality of the secondary battery, wherein the plurality of secondary batteries are electrically connected in series, in parallel, or in combination of series and parallel.

<9> A vehicle comprising the battery pack according to <6> to <8>.

<10> The vehicle according to <9>, comprising a mechanism configured to convert kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising
an active material-containing layer containing an active material and a fibrous carbon material,
wherein the active material includes primary particles containing a nickel containing composite oxide having a layered structure,
an average particle size of the primary particles is within a range of 0.1 μm or more and 10 μm or less, and
FUₐᵥₑ of the primary particles is 0.70 or more,
where the FUₐᵥₑ is an average value of a coefficient of form unevenness FU represented by the following expression (1):
$$\begin{matrix}( Math 1 ) & \\ FU = \frac{f}{{f}_{c}} = \frac{4 π a}{{ℓ}^{2}} & ( 1 )\end{matrix}$$
wherein l is an outer peripheral length of each of the primary particles in a projected cross-section, and a is an area of the projected cross-section.

2. The electrode according to claim 1,
wherein the following expression (2) is satisfied:
lₐᵥₑ/Lₐᵥₑ≤5.0, Expression (2):
the Lₐᵥₑ is an average fiber length of the fibrous carbon material, and
the lₐᵥₑ is an average value of the l of the primary particles.

3. The electrode according to claim 1,
wherein the primary particle containing the nickel containing composite oxide having a layered structure contains nickel, cobalt and manganese,
the electrode satisfies the following expressions (3) and (4):
z/x≥1/3 Expression (3):
y≤2, Expression (4):
the x is a relative amount of the nickel to a total amount of the nickel, the cobalt and the manganese,
the y is a relative amount of the cobalt to the total amount, and
the z is a relative amount of the manganese to the total amount,
where the total amount is assumed to be 10.

4. The electrode according to claim 1,
wherein the active material-containing layer further contains a granular carbon material, and
an average primary particle size r′ of the granular carbon material is not less than 5 times and not more than 12 times of an average fiber diameter r of the fibrous carbon material.

5. A secondary battery comprising:
a positive electrode;
a negative electrode; and
an electrolyte,
the positive electrode comprising the electrode according to claim 1.

6. A battery pack comprising the secondary battery according to claim 5.

7. The battery pack according to claim 6, further comprising:
an external power distribution terminal; and
a protective circuit.

8. The battery pack according to claim 6, comprising a plurality of the secondary battery, wherein the plurality of secondary batteries are electrically connected in series, in parallel, or in combination of series and parallel.

9. A vehicle comprising the battery pack according to claim 6.

10. The vehicle according to claim 9, comprising a mechanism configured to convert kinetic energy of the vehicle into regenerative energy.
